(19) United States
(12) Patent Application Publication
(10) Pub. No.: US 2023/0129705 A1
(43) Pub. Date: Apr. 27, 2023

(54) SYSTEM AND METHOD FOR CERTIFIED DATA STORAGE AND RETRIEVAL

(71) Applicant: DOS CENTAVOS, LLC, EVERETT, WA (US)

(72) Inventors: CHRISTOPHER A. WIKLOF, EVERETT, WA (US); CHRIS TROUTNER, ANACORTES, WA (US)

(21) Appl. No.: 17/663,007

(22) Filed: May 11, 2022

Related U.S. Application Data
(60) Provisional application No. 63/187,192, filed on May 11, 2021.

(51) Int. Cl. G06F 21/62; G06F 21/60

(52) U.S. Cl. CPC G06F 21/6218; G06F 21/602

(57) ABSTRACT

A computer method, graphical user interface, non-transitory computer readable medium, and system provides a facility for storing data to inherently maintain immutable proof of content as originally stored, including encrypted content. User-specific access to payload data may be provided according to selected credential privilege carried by metadata instances.

One or more blockchain transactions carry data for accessing stored data instances on a distributed file system (DFS), such as IPFS or FileCoin, or web address.

### CROSS REFERENCE TO RELATED APPLICATIONS

The present application claims priority benefit from U.S. Provisional Patent Application No. 62/832,395, entitled “SYSTEM AND METHOD FOR CERTIFIED DATA STORAGE AND RETRIEVAL,” filed May 11, 2021 (docket number 3034-004-02), which, to the extent not inconsistent with the disclosure herein, is incorporated by reference.

### SUMMARY

According to an embodiment, inventors seek to provide a payload data referencing system, akin a use of file allocation tables, formed as append-only records. The append-only records are recorded as carried data fields in block chain transactions. The carried data may be included in a public-visible field, such as an OP_RETURN field and equivalents thereof. The carried data may refer to a content identified (CID) storage location, such as a CID located on a distributed file system (DFS) such as the interplanetary file system (IPFS). Embodiments use a CID to access an equivalency table, such as a JavaScript Object Notation (JSON) object. This approach inherently provides proof of existence, history of existence, and verified contemporaneous agreements related to payload data vis-à-vis inter-user contractual relationships. This approach is especially useful as a layer in a full stack solution for driving transparent, immutable, records related toto real world objects, streams, events, rights, etc. Actual reduction to practice has involved an unspent transaction output (UTXO) blockchain. The inventors contemplate equivalent methods applied to other blockchains.

According to embodiments, at least a version of payload data (including relevant agreement(s) thereto) is provided to a user computing apparatus, for display by a GUI on an electronic display of the user computing apparatus, according to a verified agreement. According to embodiments, payload data is written to and read from, in encrypted form, one or more IPFS nodes, optionally via FileCoin arbitration.

According to an embodiment, a computer method for immutable data storage includes driving a graphical user interface (GUI) on an electronic display of a user device to present a create-project control or menu. Actuation of the create-project control or menu is received into a server computer. The server computer responsively causes an electronic wallet to be created. The electronic wallet may be a hierarchical deterministic (HD) wallet generated from a mnemonic, such as a twelve-word mnemonic, the mnemonic being saved to an authorization server. The server computer further causes a payload address and a metadata address to be generated from the electronic wallet. The server computer further generates two decryption keys, a blockchain decryption key and a storage decryption key, and saves the keys to the authorization server. For symmetric encryption embodiments, the storage decryption key and the blockchain decryption key may also serve as respective encryption keys (which may also be called passwords). The computer method further includes causing a project control corresponding to the electronic wallet to be displayed in the GUI, and creates a metadata instance at the metadata address.

According to an embodiment, a computer method for immutably storing data includes driving the GUI, receiving selection of a project control (or, in the case of a new project, holding a new (current) electronic wallet as context), and receiving designation of a file for upload into a server computer. Optionally, the method 700 may include receiving selection of whether the file is intended to be private (encrypted) or public (not encrypted). In an embodiment, encryption is selected by default. The designated file may be encrypted with a storage encryption key and saved to a storage location. In an embodiment, an encrypted file may be stored in a distributed file system (DFS) (such as IPFS, FileCoin, or a vendor storage service) and a storage location such as a path or a content identifier corresponding to the storage location read. The term content identifier may be used interchangeably with the acronym CID. In an embodiment, a non-encrypted file may be posted at a DFS, uniform resource locator (URL), or an Internet Protocol (IP) address. For cases where the file is posted to a URL or IP address, a hash of the file may be taken to provide subsequent verification that the file is as-filed with no subsequent modification. The hash of the file may be prepended or appended to the file, may be written to the metadata at the metadata address, or may be recorded as carried data as a blockchain transaction.

The computer method may include creation of a new metadata entry including a user ID, a timestamp, and the storage location. The metadata may be encrypted with the storage key, hashed, and stored at a DFS CID location per transaction or per time interval. The metadata CID may be encrypted with a blockchain encryption key. The server computer may drive a blockchain transaction with the encrypted metadata CID as carried data (such as in an OP-return field, memo field, etc.). The metadata may also remain saved at the metadata address derived from the project electronic wallet. Past instances of metadata can form “breadcrumbs” to read past states. In an embodiment, past instances of the metadata provide indelible proof of existence of payload data hashes. Since hashes are one-way functions, it is very difficult to guess at alternative format-valid metadata that one might substitute to change a file. For this reason, among others, it can be very difficult to spoof fixed data that remains current (and hence hashed to the previous CID value), and for all envisioned purposes, a stable metadata (and/or payload) may be regarded as self-proof. Similarly, past metadata (and/or payload) values can be proven as long as a file copy sharing a hash value with a past CID is maintained at any location.

According to an embodiment, a computer method for immutable data retrieval includes using a computer system to drive a graphical user interface (GUI) to present rendered blockchain-mediated payload data to a user. The method includes causing display, on an electronic display of a user device, a graphical user interface (GUI). The GUI may include a projects region that displays one or more project controls corresponding to one or more respective electronic wallets. The GUI further includes a payload data region that displays one or more payload data controls. The payload data region may display one or more payload data controls that correspond to a selected project control. The computer method may further include receiving selection of a project control into a server computer from the user device via the GUI, thereby receiving selection of a payload control into the server computer. The computer method may further include reading, with the server computer from a computer memory, a metadata instance carrying a reference to at least one blockchain transaction ID. The computer method may further include reading, from the metadata instance, the blockchain transaction ID corresponding to at least one previous blockchain transaction, and reading, with the server computer, from a computer having a non-transitory computer readable medium carrying a node of a blockchain, a blockchain transaction corresponding to the transaction ID. The method may further include reading a carried data field (such as an OP_Return value, a memo field, metadata, etc.) associated with the blockchain transaction.

The carried data field may be password-protected, symmetrically encrypted, or asymmetrically encrypted. The method may include decrypting the carried data field corresponding to a metadata or payload data instance. The carried data may include a CID to payload storage on a DFS, a URL, and/or an Internet Protocol address. The computer method may further include decrypting the carried data with a blockchain decryption key to obtain the payload or metadata storage location. The computer method may include reading the payload data or metadata. The computer method may include decrypting, with a storage decryption key, the encrypted payload data or encrypted metadata to produce payload data or metadata. The computer method may include causing the payload data to be rendered on the electronic display of the user device. The computer method may additionally or alternatively include causing the payload data to be expressed by a hardware transducer (in addition to or instead of the electronic display of the user device) for producing a user experience (UX) according to the payload data.

According to an embodiment, a non-transitory computer readable memory carries computer-executable instructions for executing computer methods for immutable data storage and retrieval.

According to an embodiment, a computer system for immutable data storage and retrieval includes a back-end server providing a rest API and an authorization server. An application platform (which may include an application server or a user device) is operatively coupled to the back end server and operatively coupled an electronic display on a user device for displaying a graphical user interface (GUI) driven by a computer application running on the application platform. In an embodiment, the application is a web application that runs on a server and cooperates with a web browser running on the user device. In other embodiments, the application is a local application that runs on the user device. The application cooperates with the back-end server to provide immutable blockchain mediated data storage and retrieval. The back-end server is operatively coupled to a node of a distributed file system (DFS) for holding (at least some) payload data and metadata that tracks the payload data. The back-end server is also operatively coupled to a blockchain that carries data in blockchain transactions, the carried data including CID data that identifies storage locations in the DFS. Electronic wallets carry metadata instances that provide links to blockchain transactions that carry CIDs. In an embodiment, a user may access payload data by selecting a project control on the GUI, the project control representing an electronic wallet; and selecting a payload control on the GUI, the payload control representing a payload instance associated with the project. The back-end server responsively reads a current metadata at a metadata address to obtain a blockchain transaction ID, reads the blockchain transaction ID to obtain carried data, decrypts the carried data with a blockchain decryption key to obtain a CID associated with the selected payload control, reads the DFS CID to obtain encrypted payload data, decrypts the encrypted payload data with a storage decryption key to obtain payload data, and presents the payload data to the user. The back-end server may further log the user access of the payload data in the current metadata, encrypt a copy of the current metadata with a storage encryption key, save the encrypted metadata at a new CID in the DFS, encrypt the new CID with a blockchain encryption key, write a transaction to the blockchain with the encrypted new CID as carried data, determine a transaction ID for the transaction, and write the transaction ID to the current metadata.

According to an embodiment, a computer method for driving a graphical user interface (GUI) to present rendered payload data to a user includes causing display, on an electronic display of a user device, a graphical user interface (GUI). The GUI may include a projects region that displays one or more project controls corresponding to one or more respective electronic wallets, and a payload data region that displays one or more payload data controls. The computer method further includes reading, with the server computer from a computer memory, a metadata instance corresponding to the one or more electronic wallets represented by the one or more project controls, and identifying, in the metadata instance, a first storage location in a DFS of first payload data instance holding a thumbnail image corresponding to a second payload data instance. The computer method further includes reading the first storage location of the DFS to obtain the first payload data instance, decrypting the first payload data instance to obtain the thumbnail image, and causing display, with the server computer, of the thumbnail image as at least a portion of a corresponding one of the one or more electronic wallet controls.

According to an embodiment, a computer method for driving a graphical user interface (GUI) to present rendered payload data to a user includes causing display, on an electronic display of a user device, a graphical user interface (GUI). The GUI may include a projects region that displays one or more project controls corresponding to one or more respective electronic wallets, and a payload data region that displays one or more payload data controls. The computer method further includes receiving selection of one or more project controls into a server computer from the user device via the GUI, reading, with the server computer from a computer memory, a metadata instance corresponding to the one or more electronic wallets represented by the one or more project controls, and causing display, with the server computer, of a payload data control in the payload data region of the GUI corresponding to at least a subset of blockchain transactions referenced by the metadata instance.

According to an embodiment, a computer method for providing immutable proof of prior data existence includes driving a graphical user interface (GUI) on an electronic display of a user device to present a create-project control or menu, receiving, into an application program running on hardware, actuation of the create-project, and responsively to receiving actuation of the create-project, causing an electronic wallet to be created. The computer method includes causing a payload address and a metadata address to be generated from the electronic wallet, generating two decryption keys, a blockchain decryption key and a storage decryption key, causing a metadata instance to be created at the metadata address, and causing a project control corresponding to the electronic wallet to be displayed in the GUI.

### BRIEF DESCRIPTION OF THE DRAWINGS

FIG. 1A is a flow chart showing a computer method for presenting immutable payload data to a user, according to an embodiment.

FIG. 1B is a flow chart showing a computer method for presenting immutable payload data to a user, including caching a metadata instance, according to an embodiment.

FIG. 2 is a system diagram showing principal portions of a system for presenting immutable payload data to the user according to the computer methods of FIGS. 1A, 1B, 5, and 8; and for storing data according to the computer methods of FIGS. 6 and 7; according to embodiments.

FIG. 3 is a diagram of a graphical user interface (GUI) for presenting immutable payload data to a user, according to an embodiment.

FIG. 4 is a diagram of a GUI for presenting immutable payload data to a user, according to another embodiment.

FIG. 5 is a flow chart showing a computer method for obtaining blockchain-mediated metadata, according to an embodiment.

FIG. 6 is a flow chart showing a computer method for creating a project wallet for storing payloads tracked by blockchain transactions, according to an embodiment.

FIG. 7 is a flow chart showing a computer method for payload creation in the context of a project, according to an embodiment.

FIG. 8 is a flow chart showing a computer method for reconstruction of a project and payloads tracked by the project, according to an embodiment.

FIG. 9 is a flow chart showing a computer method for creating a project corresponding to an electronic wallet, according to an embodiment.

FIG. 10 is a view of a graphical user interface (GUI) 1000 including a new project control 1002, according to an embodiment.

FIG. 11 is a view of a GUI 1100 including an add-new-project view 1102 including a project name selector 1104 and a submit control button 1106, according to an embodiment.

FIG. 12 is a view of a GUI 1100 including an add-new-document control 1204 in the context of a selected project 1202, according to an embodiment.

FIG. 13A is a flow chart showing a portion of a computer method 1300 for creating a payload associated with the selected project 1202 of FIG. 12, according to an embodiment.

FIG. 13B is a flow chart showing another portion of the computer method 1300 for creating the payload associated with the selected project 1202 of FIG. 12, according to an embodiment.

FIG. 14A is a view of a GUI 1400 including an add-new-document view 1402 including a payload title control 1404, and a file selector 1406, according to an embodiment.

FIG. 14B is a view 1401 of the GUI including the add-new-document view 1402 of FIG. 14A with the title inserted and a file 1410 entered, according to an embodiment.

FIG. 14C is a view 1403 of the GUI 1400, 1401 including the add-new-document view FIGS. 14A and 14B showing another portion of the add-new document view 1402, according to an embodiment.

FIG. 15 is a view of a GUI 1500 including a selected project 1202 and a payload control 1502, according to an embodiment.

FIG. 16 is a flow chart showing a computer method 1600 for controlling aspects of the payload including payload viewing and blockchain transaction viewing, according to an embodiment.

FIG. 17 is a view of a GUI 1700 including a payload control view 1702, according to an embodiment.

FIG. 18 is a view of a GUI 1800 including a payload view 1802 displayed responsive to actuation of a view-file control 1704 in the payload control view 1702 of FIG. 17, according to an embodiment.

FIG. 19 is a block explorer view 1099 corresponding to a transaction ID 1902 corresponding to broadcast of a blockchain transaction carrying data 1904 corresponding to a payload CID, made responsive to user actuation of a blockchain transaction ID (TX) 1706 displayed in they payload control view 1702 of FIG. 17, according to an embodiment.

FIG. 20 is a flow chart showing a computer method 2000 for controlled sharing of a payload with a counterparty, according to an embodiment.

FIG. 21 is a view of a GUI 2100 including a share-document-with-others control view 2102, according to an embodiment.

FIG. 22 is a view of a counterparty GUI 2200 including a shared payload control 2202, according to an embodiment.

FIG. 23 is a view of a payload control view 1702 displayed to the counterparty responsive to receiving the counterparty's actuation of the shared payload control 2202 of FIG. 22, according to an embodiment.

FIG. 24 is a flow chart showing a computer method 2400 for providing a proof or certification that the payload is genuine, according to an embodiment.

FIG. 25A is a view 2500 of a GUI displayed to a user responsive to actuation of a proof control button 1716 in the payload control view 1702 of FIG. 17, according to an embodiment.

FIG. 25B is another view 2501 of the GUI 2500 of FIG. 25A, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here.

A CID is a technology for pointing to content saved on a distributed file system (DFS) such as InterPlanetary File System (IPFS). A CID is a multi-hash of a file that points to a storage location where the file is saved.

As used herein, a project refers to an electronic wallet. According to embodiments, addresses are generated from a hierarchical deterministic wallet or HD wallet. As used herein, the terms project and electronic wallet may be used interchangeably and may be considered synonymous, unless context indicates otherwise.

As used herein, each of a group of files tracked by a project or electronic wallet may be referred to as a payload or payload file, (which may be considered synonymous with one another) or may be considered metadata or a metadata file (which may be considered synonymous with one another). A payload may be any file corresponding to a computer data file designated by a user for inclusion in a project. Metadata may be any file generated by a system described herein for carrying information about one or more payloads in a project, or in the case of project metadata, for carrying information about a project, an electronic wallet, key pairs, and/or addresses associated with the electronic wallet.

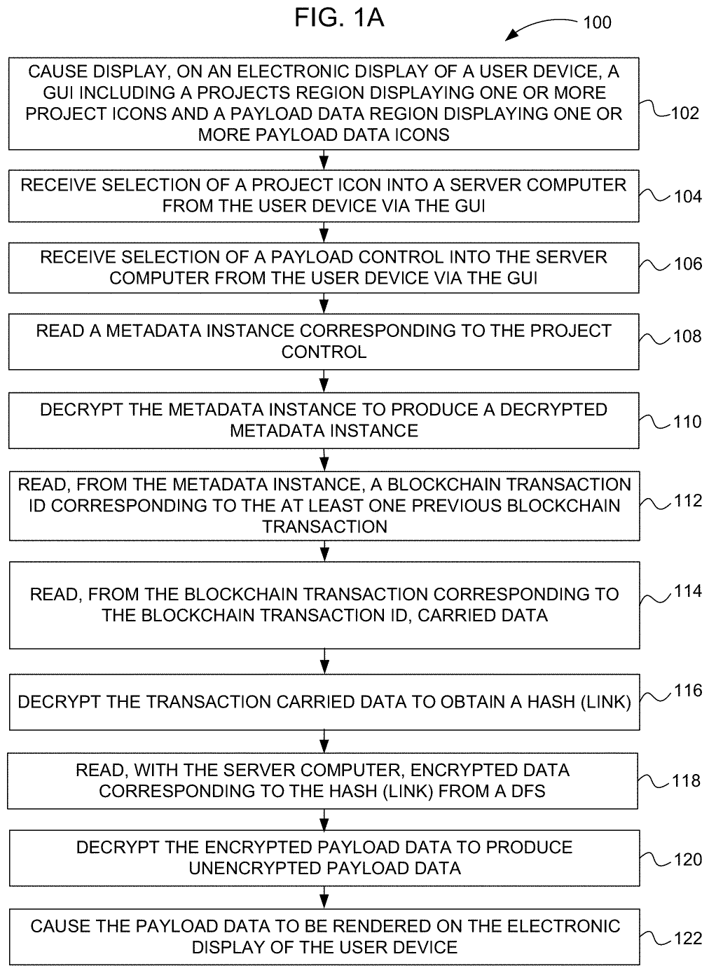

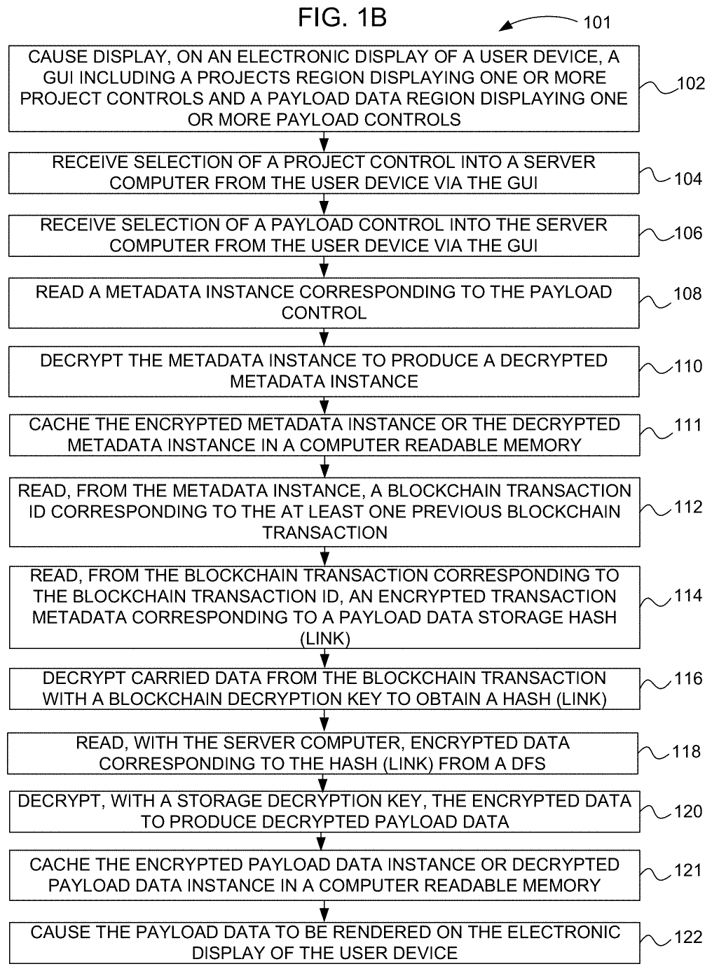

FIG. 1A is a flow chart showing a computer method 100 for presenting payload data to a user, according to an embodiment.

FIG. 1B is a flow chart showing a computer method 101 for presenting payload data to a user, including caching a metadata instance, according to an embodiment.

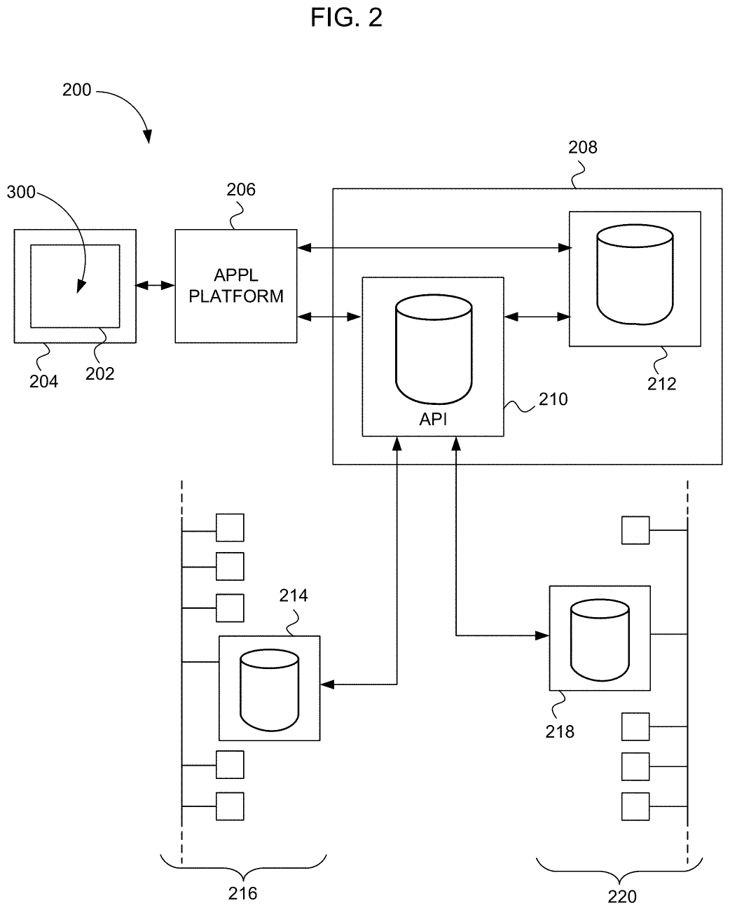

FIG. 2 is a system diagram showing principal portions of a system 200 for receiving, tracking, and presenting payload data to the user according to the computer methods described herein, according to embodiments.

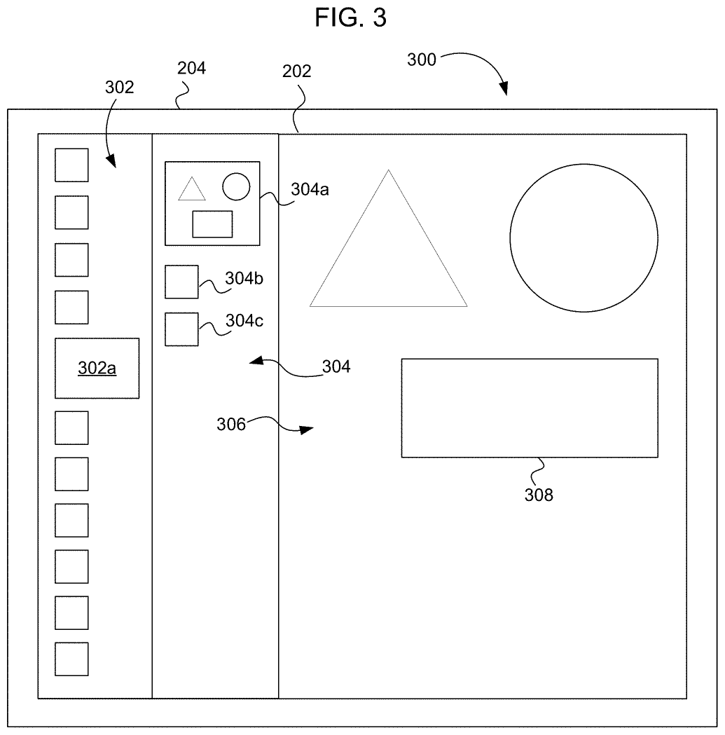

FIG. 3 is a diagram of a graphical user interface (GUI) 300 for receiving and presenting payload data to a user, according to an embodiment.

According to an embodiment, referring to FIGS. 1A, 2 and 3, a computer method 100 for using a computer system 200 for driving a graphical user interface (GUI) 300 to present payload data to a user includes, in step 102, causing display, on an electronic display 202 of a user device 204, a graphical user interface (GUI) 300. In an embodiment, the computer system 200 includes an application platform 206 configured to run a “front-end” application. The application platform 206 may be deployed on a server, for example for a web application (“web app”) environment. In another embodiment, the application platform 206 may include circuitry in the end user device 204, for example for a mobile application or desktop application environment. Alternatively, the application platform 206 may be split, with part of the front-end application being performed on a server computer and another part of the front-end application being performed on a user device 204.

In an embodiment, the computer system 200 includes a “back-end” server platform 208 that includes one or more server computers. In an embodiment, the back-end server 208 includes an application programming interface (API) server 210 that supports a rest API, and an authorization server 212 that provides authorization of users. Connectivity between the optionally separate application platform 206, the server 208, and the optional separate API server 210 and authorization server 212 may be selected according to normal engineering preferences. For purposes of simplification and ease of description, description of back-end functions herein will generally refer to a server computer 208 that may include both an API server 210 and an authorization server 212, and optionally including additional servers such as a web server(s), load balancing server(s), RAID server(s), etc. Optionally, the server computer 208 may be deployed on a cloud service.

According to embodiments, the server computer 208 reads and broadcasts blockchain transactions on a non-transitory computer-readable memory of a device 214 linked to a blockchain 216. According to embodiments, the server computer 208 performs read/write of data on a computer 218 linked to a distributed file system (DFS) 220.

As described herein, a transaction on the blockchain 216 provides reference to a corresponding metadata instance and/or payload data instance stored on the DFS 220. According to embodiments, the blockchain 216 may include a public blockchain. Public blockchains provide immutable tracking of transactions but may be too expensive to use for general purpose storage of data. Accordingly, the system 200 described herein may provide blockchain 216 mediation or tracking of (e.g., reference to) data storage on the DFS 220 for data payloads. Embodiments described herein may be valuable for providing security for permissioned data access between parties engaged in business negotiations. For example, data payloads may include trade secrets, binding legal agreements, binding social agreements, investor slide decks, recipient responses to investor slide decks, access logs, and other documents for which proof of validity is important. In other embodiments, the inventors contemplate that payload data may include software carrying use contracts including open-source software, accounting ledgers for attributing value disbursement, corporate “books”, original works of various types (encrypted or not encrypted), client lists, personal account storage and recovery, and other uses.

Among other advantages, this approach has been found to minimize blockchain transaction fees compared to storage of data directly on the blockchain 216 (insofar as blockchain transaction fees may be proportional to an amount of data carried by a transaction) while providing unlimited storage capacity.

As used herein, the term blockchain mediation, blockchain referenced data, and the like refers to a system wherein locations of metadata and of payload data in a DFS, and in some cases, hash values of files, are tracked by carried data in blockchain transactions. According to embodiments, data carried in a blockchain transaction corresponds to DFS storage locations. The carried data may be referred to as memo data such as OP_RETURN data carried in a transaction. As used herein, DFS “address”, “storage location”, and the like may be referred to as a cryptographic hash (specifically, a multi-hash) of data content saved at the storage location that operates as a link for query. This may be referred to as a CID. According to embodiments, an immutable address other than a CID per se may be used to address a payload and/or a payload metadata instance and may be considered equivalent thereto.

According to embodiments, the system described herein may also be used to link to encrypted or non-encrypted data at a uniform resource locator (URL), Internet protocol (IP), and/or other address. Unless context indicates to the contrary a link to a CID may also refer to a link to a URL or IP address. The use of a conventional HTML-accessible link may be particularly useful as an approach to providing linked and/or crawlable public information or advertisement about a related, encrypted or public, payload.

Referring to FIG. 3, in an embodiment, the GUI 300 includes a projects region 302 that displays one or more project controls 302a corresponding to one or more respective electronic wallets. Each electronic wallet may be embodied as a 12-word mnemonic saved on an authorization server (e.g., 212 in FIG. 2) or in project metadata in custody of the system 200. The 12-word mnemonic operates as a seed to a hierarchical deterministic (HD) wallet and, along with a derivation path, to one or more private-public key pairs for encryption and one or more addresses for transactions. In an embodiment, the GUI 300 further includes a payload data region 304 that displays one or more payload data controls or representations respectively corresponding to one or more payload instances 304a, 304b, 304c associated with a selected project or electronic wallet 302a. As used herein, the terms payload, payload data, payload instance, and payload data instance shall be considered synonymous unless further definition is provided.

Referring again to FIGS. 1A, 1B, and 2, the computer method 100, 101 further includes, in step 104, receiving selection of a project control 302a into a server computer 208 from the user device 204 via the GUI 300. Step 106 includes receiving selection of a payload 304a, 304b, 304c into the server computer 208 from the user device 204 via the GUI 300. Step 108 includes reading, with the server computer 208 from a database and/or from a DFS 220, a metadata instance. Step 112 includes reading, from the metadata instance, a blockchain transaction ID (TX, or TXID) (which operates as a universally unique identification of a particular blockchain transaction) corresponding to the at least one previous blockchain transaction. Step 114 includes reading, with the server computer 208, from the blockchain transaction corresponding to the blockchain transaction ID, carried data (e.g., OP-_RETURN value) corresponding to a payload data storage CID. In an embodiment, the method includes step 116 wherein the carried data is decrypted to obtain a CID. In another embodiment, the carried data carries a non-encrypted CID. Step 118 includes reading, with the server computer 208, optionally encrypted data corresponding to the CID from a distributed file system (DFS) 220. Optional step 120 includes decrypting (if the data at the CID is encrypted), with a storage or metadata decryption key, the encrypted data to produce payload data or metadata. In an embodiment, the storage or metadata decryption key is the private key associated with the project. Step 122 includes causing the payload data to be rendered on the electronic display 202 of the user device 204.

In an embodiment, stored payload data 308 may additionally be cached on the server computer 208. In an embodiment, the blockchain 216 mediation and DFS 220 resources are used for system initiation, for verification of authenticity, and/or for system recovery, and cached data in a database are used to provide a responsive interface to the user. In another embodiment, blockchain 216 and DFS 220 records may provide an indirect interface to a different system to which a user has access.

Referring to FIGS. 1A-1B, in step 108, reading the metadata instance may include reading an encrypted metadata instance from a metadata CID, and decrypting the metadata instance with a decryption (private) key or a password.

In one embodiment, referring to FIG. 1B, the computer method 101 may further include, in step 111, caching the encrypted metadata instance or the decrypted metadata instance in a computer readable memory accessible by the server computer 208. In another embodiment, the computer method 101 may further include, in step 121, caching the encrypted payload data instance or the decrypted payload data instance in a computer readable memory accessible by the server computer 208.

In one embodiment, referring to FIG. 3, the payload data may be rendered in a payload rendering region 306 of the GUI 300 as rendered payload data 308. In another embodiment, the payload data may be rendered on a desktop surface, for example on a region of the desktop surface that is overlaid with a transparent payload rendering region 306 or in a pop-up window.

In an embodiment, referring to FIGS. 1A-3, receiving selection of the payload control 304a, in step 106, may include receiving a selection of a plurality of payload controls 304a, 304b, 304c. In another embodiment, receiving selection of the payload control 304a, in step 106, includes receiving a default selection that does not require a user input. Receiving the selection of a payload control 304a, in step 106, may include receiving a selection of at least two payload controls 304a, 304b. The payload data 308 corresponding to a first payload control 304a may include a thumbnail image corresponding to second payload data 308b. In an embodiment, receiving selection of payload data corresponding to a thumbnail image includes an automatic selection. The automatic selection may optionally be controlled by a user preference table.

In an embodiment, in step 108, reading, with the server computer 208 from the computer memory, the metadata instance tracked by the at least one blockchain transaction includes reading an encrypted metadata instance. The computer method 100 may further include, in step 110, decrypting the metadata instance using a key or password associated with the selected electronic wallet to produce a decrypted metadata instance. In an embodiment, in step 112, reading, from the metadata instance, the blockchain transaction ID corresponding to the at least one previous blockchain transaction includes reading the blockchain transaction ID from the decrypted metadata instance.

In an embodiment, in step 108, reading, with the server computer 208 from the computer memory, the metadata instance includes reading the metadata instance from the node 218 of the DFS 220.

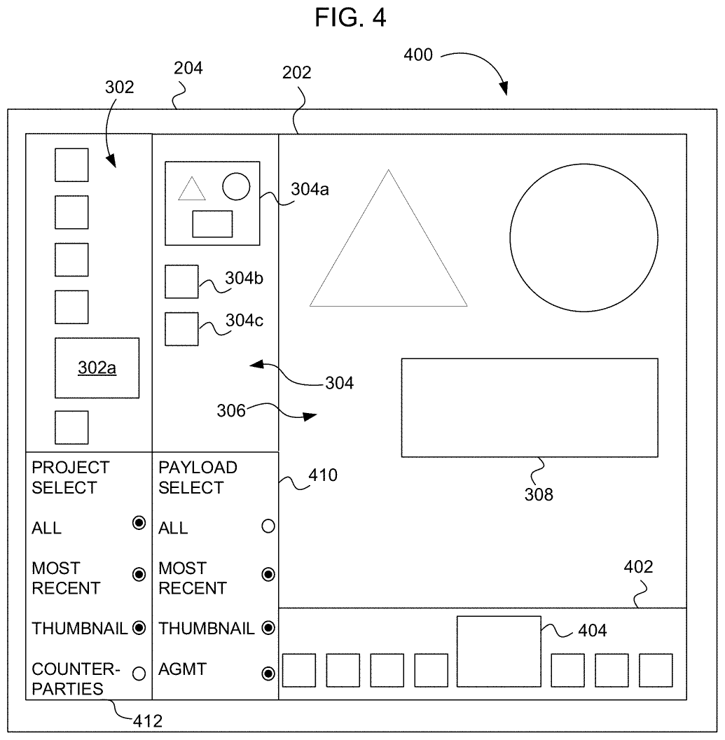

FIG. 4 is a diagram of a GUI 400 for presenting a payload to a user, according to an embodiment.

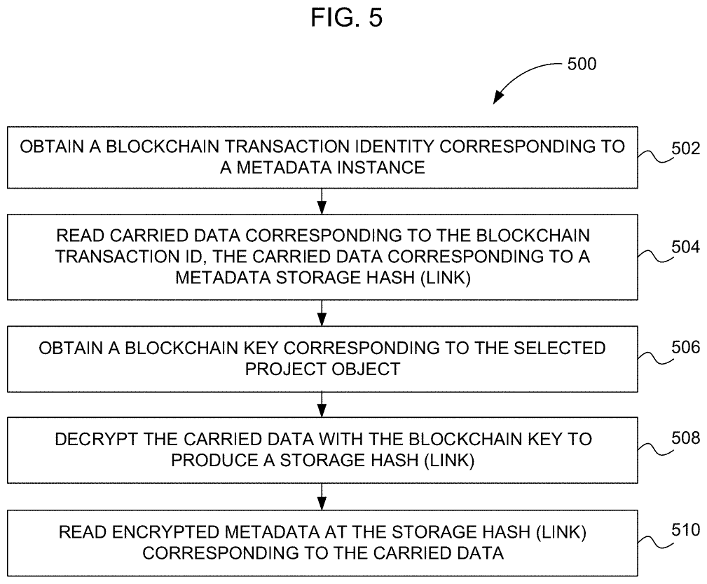

FIG. 5 is a flow chart showing a computer method 500 for obtaining blockchain-mediated metadata, according to an embodiment.

In an embodiment, referring to FIGS. 1A-1B, 2 and 5, in step 108, reading, with the server computer 208 from the computer memory, the metadata instance corresponding to the project further includes, in step 502, obtaining a blockchain transaction ID corresponding to a previous metadata instance. According to an embodiment, the server computer reads blockchain transactions referencing the project electronic wallet, for example using a block explorer tool. A search for a transaction corresponding to receiving and saving one or more payloads is deterministic if carried (e.g., OP_RETURN) data is not pruned or truncated from the blockchain. The server computer may query CIDs associated with carried data to find a metadata instance holding information related to one or more particular payloads. The most recent transaction or two may generally carry reference to the most recent previous instance of metadata, according to an embodiment.

As referred to herein, a blockchain transaction ID (synonymous with TX or TXID unless context indicates otherwise) provides deterministic reference to the identity of a particular blockchain transaction associated with the project. Step 504 includes reading carried data corresponding to the blockchain transaction ID, the carried data corresponding to a metadata storage CID. Since carried data corresponding to a transaction is immutable, reference to a previous metadata instance is similarly certain. Step 510 includes reading encrypted metadata at the metadata storage CID corresponding to the carried data.

In an embodiment, in step 108, reading, with the server computer 208 from the computer memory, the metadata instance corresponding to the at least one blockchain transaction further includes, in step 506, obtaining a storage decryption key (optionally, a metadata-specific storage decryption key, such as when particular wallet address is associated with a private-public key pair used to encrypt and decrypt all metadata storage transaction instances) corresponding to the selected project view or control 302a. In an embodiment, step 508 includes decrypting the carried data with a blockchain decryption key or password to produce the metadata storage CID. In another embodiment, the carried data at least partially includes an unencrypted CID.

In an embodiment, referring to FIGS. 1A-1B, 2 and 4, the GUI 300 further includes a region 402 that displays one or more views or controls corresponding to counterparties with whom at least one payload in the project has been shared. In one embodiment, the counterparties amount to linked crosstab project controls or views 404 corresponding to projects 302a into which the payload has been shared. In another embodiment, the region 402 displays controls representing counterparty user identities (and/or shadow user identities, described below). Receiving selection of a project control 302a into the server computer 208 from the user device 204 via the GUI 300, in step 104, may cause the server computer to read project model or payload model metadata to identify other projects with which the selected project has a tracked relationship. For example, a cross-tabulated project may be a project established by a counterparty in a business deal, where the user is engaged with sharing or receiving secret information under a non-disclosure agreement. Payload data in both projects may include a signed non-disclosure agreement binding the parties with respect to use of shared secrets (sharing agreements) plus shared secrets (payloads). Either party may additionally have other payload data in respective projects that is not shared with the counterparty.

Step 104 may include receiving selection of the one or more linked controls 404. The payload data region 304 may display the one or more payload controls 304a, 304b, 304c to which the respective projects have access. Reading, with the server computer 208 from the computer memory, the metadata instance corresponding to the project(s), in step 108, may include reading, from the metadata, a listing of payload data to which both the selected project and the selected linked project have access privileges.

In an embodiment, the GUI 300 further includes a payload rendering region 306. Causing the payload data 308 to be rendered on the electronic display 202 of the user device 204, in step 102, may include displaying the payload data 308 in the payload rendering region 306.

In an embodiment, the GUI 300 further includes a filter selector 410 for the payload data region 304. The GUI 300 further may include filtering the one or more payload control 304a, 304b, 304c selected for display according to the selected filters for payload controls 304a, 304b, 304c. Receiving selection of the payload control 304a, in step 106, may include receiving the selection of one of the one or more filtered payload controls 304a, 304b, 304c. One filter may be configured to select only most recent versions of respective payload data 308. In another embodiment, one filter may be configured to select only at least one sharing agreement payload data 304c that governs a use of information to which the counterparty 404 represented in the region 402 is granted access. The at least one sharing agreement may include a non-disclosure agreement, a confidentiality agreement, a socially enforced promise of secrecy, an acknowledgement of authorship or ownership, a use limitation agreement, an open-source license, a conventional license, a memorandum of understanding, a term sheet, a contract, an acknowledgement of receipt, and/or an acknowledgement of reading. Other types of sharing agreements will become clear as use cases emerge and should be considered covered by the general term “sharing agreement”.

In an embodiment, the metadata instance 204a, 204b consists essentially of a JavaScript Object Notation (JSON) object. In another embodiment, the metadata instance 204a, 204b includes a locally stored metadata instance 204b corresponding to an encrypted metadata instance 204a stored on the DFS 220 with blockchain 216 mediation.

As used herein, the term “blockchain mediation” and the like refers to a system where locations of metadata and of payload data in a DFS are tracked by carried data in blockchain transactions, the carried data corresponding to encrypted DFS hash (links).

Referring to FIG. 2, according to an embodiment, a computer system 200 includes a back-end server 208 providing an API server 210 providing rest API and an authorization server 212. An application platform 206 (which may include an application server or a user device) is operatively coupled to the back end server 208 and operatively coupled an electronic display 202 on a user device 204 for displaying a graphical user interface (GUI) 300 driven by a computer application running on the application platform 206. In an embodiment, the application is a web application that runs on a server and cooperates with a web browser running on the user device. In other embodiments, the application is a local application that runs on the user device. The application cooperates with the back-end server 208 to provide immutable blockchain mediated data storage and retrieval. The back-end server 208 is operatively coupled to a linked device 218 of a distributed file system (DFS) 220 for holding (at least some) payload data and metadata which tracks the payload data. The back-end server 208 is also operatively coupled to a linked device 214 of a blockchain 216, the blockchain including transactions carrying access data for metadata files (and optionally payloads) stored in the DFS 220. The carried data includes CID data that identifies storage locations in the DFS 220. Electronic wallets are referenced in blockchain transactions carrying metadata or metadata instances that provide links to metadata (and optionally payloads) stored in the DFS.

In an embodiment, a user may access payload data by selecting a project control in the GUI 300, the project control representing an electronic wallet; and selecting a payload control on the GUI 300, the payload control representing a payload instance associated with the project. The back-end server 208 responsively reads transactions referencing the project wallet to obtain a blockchain transaction ID, reads the blockchain transaction ID from the blockchain node 214 to obtain carried data, may decrypt optionally encrypted carried data with a project decryption key or password to obtain a CID to metadata associated with the selected payload control, reads the DFS CID from the DFS 218 to obtain encrypted payload data, decrypts the encrypted payload data with a project decryption key or password to obtain payload data, and presents the payload data to the user via the user device 204. The back-end server 208 may further log the user access of the payload data in the current metadata, encrypt a copy of the current metadata with aan encryption key (also referred to as a public key) or password, save the encrypted metadata at a new CID in the DFS 220 at the DFS-linked device 218, optionally encrypt the new CID with an encryption key or password, and broadcast a transaction to the blockchain 216 carrying the new CID or encrypted new CID as carried data. In an embodiment, the server computer may determine a transaction ID for the transaction and write the transaction ID to the current metadata.

In an embodiment, the DFS 204 includes a device 218 linked to the Interplanetary File System (IPFS). In another embodiment, the DFS 204 includes a device 218 linked to FileCoin.

In one embodiment, a first payload data includes a trade secret, and a second payload data includes a concise representation of the first payload data 104, such as a thumbnail image. In another embodiment, the second payload data includes an agreement for sharing the first payload data 104 between a first party and a counterparty.

According to an embodiment, the first payload data includes a trade secret, and the second payload data includes a secrecy agreement. According to another embodiment, the second payload data 108 includes a thumbnail image of the first payload data 301.

According to an embodiment, a decryption key owner or administrator, via the GUI, accesses information at a current metadata storage location, which may include a database such as MongoDB. The current metadata storage location may address a second authorization metadata storage location, and at least one of the current metadata storage location or the second authorization metadata storage location may include metadata corresponding to at least one of a white list or a black list of accessing parties respectively provided access or blocked from access to payload data.

In an embodiment, the first payload data includes a one-time access media package, and the second payload data includes a decryption key to view the one-time access media package. In another embodiment, the first payload data includes a video segment encrypted by a first user. The second payload data may include a video segment encrypted by a second user. The metadata may include a current, optionally rotating, decryption key for the first and the second payload data instances.

In an embodiment, the metadata may include an instance of JavaScript Object Notation (JSON). The JSON instance may include a specification of a previous linked JSON instance. In embodiments, the JSON instance includes a specification of a first and a second corresponding payload data instances having a relationship therebetween. Additionally, and/or alternatively, the JSON instance includes a specification of a relationship between a first and a second corresponding payload. In another embodiment, the JSON instance carries a current “black list” and/or “white list” of user identity(ies).

In an embodiment, the system provides encrypted, (payload) data storage to authorized users. The data storage may include storage at a DFS storage facility, such as IPFS. The payload data storage and retrieval procedure may include use of a CID address generated from payload content. Data storage may additionally or alternatively be designated according to a user input, such as by selecting use of a localized application, by providing a file path at a named address, and/or by insertion into a wallet transaction history. According to embodiments, the storage coordinate is encrypted.

Some applications may use a ‘permanent’ storage schema. According to an embodiment, an application may track relatively dynamic memory states. In an embodiment, the user may “archive” a payload data file to clean up a UX. The transaction of saving the payload, however, is substantially permanent, the transaction being tracked on a blockchain. According to embodiments, transaction histories are recorded as metadata files, for example as a JSON file, the JSON file being periodically encrypted and written to a then current CID, the storage location being recorded as carried data in a blockchain transaction. A series of such blockchain transactions at an address corresponding to the project wallet may thus provide a “‘breadcrumb trail to track a history of creation of payload data, changes to payload data, sharing events, access events and/or other events recorded to blockchain. Optionally, obsolete data may be periodically swept to free storage.

Referring again to FIG. 2, the computer system 200 may provide two main components, a front end 206 and a back end 208, that cooperate to provide encrypted payload data storage and retrieval on a distributed file system (DFS) 220 via access control stored on a public blockchain 216. The system 100 may use the Bitcoin Cash (BCH) blockchain for access control. In an embodiment, the system 100 may use BCH and for optional fee payment for use of the DFS and/or FileCoin.

The front end 206 may provide application support specific to a particular use case. The front end 206 may include an application operatively coupled to a physical electronic display 202. The application 206 and display 202 may be configured to provide a graphical user interface (GUI) 300 to a user. The application may include an HTML (/XML) web application that uses a cascading style sheet (CSS) standard.

For one first particular use case, trade secret management, a sponsor look, and feel may be configurable offline. The sponsor may deploy access to its users. There can be multiple sponsors. Sponsors may determine use criteria and parameters for its sponsored users.

The back end 208 may provide encrypted payload data storage and retrieval on the DFS 106 via access control stored on a public blockchain 216 responsive to communications with front end 206 instances.

The back end 208 may include an API server 210 that communicates with the front end 206 via a rest API that interfaces to the blockchain 216, the DFS 220, and an authorization server 212. The back end 208 also may include the authorization server 212 that manages user authorization and authentication and manages cryptographic key access.

A user may establish and obtain access to an account via a JWT (“jot token”) communication session between the front end 206 and the back end 208. The authorization server 212 may authorize a user session, informing both the front end 206 and the API server 210 via encrypted communications.

The application 206 may transmit (a) request(s) to the API server 210 for metadata parameters.

“Projects” may be embodied as electronic wallet addresses configured to provide destinations and/or sources for blockchain transactions to and from other wallet addresses. In this way, the system 200 may operate as a service for transmitting and receiving (optionally encrypted) linked information between users while providing an immutable, sovereign record of each transmission and/or reception transaction.

In an embodiment, when the user actuates a project control and payload control via the GUI 300, the API server 210 receives the actuation as a payload data identifier, reads metadata corresponding to the project to obtain a payload data storage CID, reads the encrypted payload data from the payload CID, decrypts the payload data, parses and encrypts the payload data per the current JWT token, transmits the payload data to the application 206, and logs the access onto the current metadata object. The application 206 may decrypt the selected payload data with the JWT session key, and drive the GUI to display the payload data to the user on the electronic display 202.

In an embodiment, a computer method and system provide a listing of previously saved payload data. A networked server may obtain metadata related to one or more payload data instances by reading blockchain transaction carried data value from a blockchain node, and obtaining the metadata instance by reading a DFS storage location corresponding to the carried data. In an embodiment, the carried data value may be decoded with a wallet decryption key to obtain the DFS storage location. In another embodiment, the networked server may obtain metadata related to two or more payload data instances by reading a blockchain transaction carried data value from a blockchain. The networked server may obtain metadata by reading the blockchain transaction value to obtain a metadata DFS CID, then reading and decrypting metadata from the metadata distributed memory storage CID. The networked server may assemble a display list corresponding to one or more of the two or more payload data instances. The networked server may transmit the display list to a user device. The user device may render the display list and displays the rendering as a portion of a graphical user interface on an electronic display.

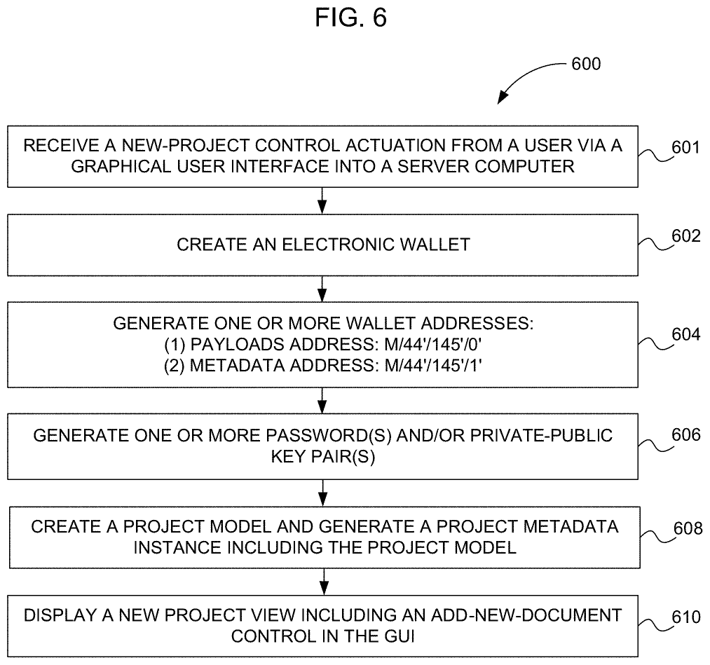

FIG. 6 is a flowchart showing a computer method 600 for project creation, according to an embodiment. For clarity, FIG. 6 and corresponding description refers to use of the Bitcoin Cash (BCH) blockchain to mediate IPFS data storage. Other blockchains and/or other distributed file systems may be substituted without departing from the scope and spirit of embodiments described herein.

A project is implemented as an electronic wallet, the electronic wallet being configured to receive payload data for immutable storage, according to an embodiment. While the term project is used herein, other terms may be similarly applied, depending on context. In one example, the term “matter” may be used to refer to cases where the electronic wallet refers to a legal file such as an invention disclosure, patent application, trademark application, tax defense, criminal defense, or the like. In another example, the term “case” may be used to refer to projects such as a tax investigation, criminal investigation, Child Protective Services case, or the like. In another example, the term “contract” may be used to refer to a process related to engagement in a business or workforce negotiation. In another example, the term “employee file” or “applicant file” may be used to refer to personnel files. In another example, the term “customer”, “client”, “patient”, etc. may be used to refer to files for containing records of persons or enterprises receiving recurring services from a user organization. In another example, the term “counterparty”, “opposition file”, “vendor”, “supplier”, and the like may refer to parties with whom a user or user organization trades or negotiates.

In an embodiment, the term used to refer to a project may be user-selectable via the GUI. User configuration for a given project may optionally be stored as a “project configuration”, tracked by payload or metadata that is stored and maintained according to approaches disclosed herein.

The process described herein creates a transparent, immutable record of document creation and access that can be used to provide proof and/or evidence related to payload data. The raw data is, in some embodiments, encrypted, which provides a happy medium between keeping information private, but proving publically that it existed. In some embodiments one or more payload data instances may be unencrypted, so as to provide public knowledge. The public knowledge may be related to one or more encrypted payload data instances, to which access may be selectively or universally granted.

As used herein, the term payload means any arbitrary binary file. The term metadata refers to a JSON object used to describe the who, what, and when of file access by users. The term project means an electronic wallet such as a Hierarchical Deterministic (HD) wallet.

According to an embodiment, a computer method 600 for creating a new project includes, in step 602, creating a seed key from a mnemonic phrase. The mnemonic generates a hierarchical deterministic (HD) wallet. The use of mnemonic phrases to generate HD wallets is defined under several Bitcoin Improvement Proposals, the first being Bitcoin Improvement Proposal 32 (BIP 32 or BIP32). Variants are described in BIP39, BIP43 and BIP44. Embodiments described herein may operate using any of BIP32, BIP39, BIP43, or BIP44, each of which is supported by one or more wallet generators in various paid and free forms for hardware, mobile, and desktop environments. An embodiment developed by the inventor uses BIP44, which uses a 12-word mnemonic. As used herein, references to BIP44 its 12-word mnemonic will be understood to also apply to embodiments using other HD wallet specifications, which are considered to fall within the scope described and claimed herein.

According to an embodiment, the system places a 12-word mnemonic in custody (in an embodiment, in a project model carried by project metadata) and provides access to a user via a conventional username/password and username/password recovery methodology. According to an embodiment, a user may be provided the 12word mnemonic as a displayed field on the GUI, so that the user may optionally store access to the seed key in separate storage or on paper. Providing the 12-word mnemonic to the user, according to the deterministic BIP 32 protocol, allows the user to access all past and future transactions involving the HD wallet (project) as a single backup event.

Optionally, the seed key may use a different number than 12 words as its mnemonic. One HD wallet vendor offers the option of 24 words. Additionally or alternatively, use of a custom and/or non-English dictionary may be used to generate the mnemonic.

Step 604 includes generating one (or more) blockchain addresses using the hierarchical function of the HD wallet. In one embodiment, a single address, which may be derived from a derivation path m/44′/145′/0′, may be used to record all transactions recording payloads, metadata, and events involving the payload. In another embodiment, two blockchain addresses are generated: (1) A payloads address, shown in FIG. 6 as m/44′/145′/0′, provides a starting address for receiving payload data for storage. (2) A metadata address, shown in FIG. 6 as m/44′/145′/1′, provides a starting address for a JSON metadata object, which provides reference and access to payload objects.

According to an embodiment, step 606 includes generating one or more random password(s) for us in symmetric encryption and decryption. For example, one password may be used for encrypted data carried by blockchain transactions and a second password for encrypted data carried by a DFS (e.g., IPFS). Additionally or alternatively, a first password may be used for encrypting payloads and a second password may be used for encrypting metadata. According to embodiments, additional passwords, such as for additional storage systems (e.g., encrypted url or IP addresses), additional payload data sets, and/or additional metadata access objects, may be generated. According to another embodiment, a wallet address private-public key pair is used respectively for decryption and encryption according to an embodiment using asymmetric encryption.

Project Creation Protocol

In an embodiment, the most fundamental primitive in this protocol is the project. Every payload and piece of metadata is associated with a project. Payloads and metadata are not allowed to exist without being associated to a project.

Users may be assigned to a project, but exist independently of projects. User interactions with payloads are recorded as metadata.

According to an embodiment, when a new project is created, a new 12-word mnemonic is generated and assigned to the project, as shown in step 602. The mnemonic is the basic information used to create an HD wallet in Bitcoin Cash (BCH). An HD wallet is capable of generating billions of addresses. For ease of understanding, the use of two addresses is described herein.

In step 604, two BCH addresses are generated from the mnemonic. The first BCH address is used to track payloads. The second BCH address is used to track snapshots of metadata. Each new payload to be added to a project is tracked via a BCH transaction written the first BCH address. Each new snapshot of metadata is tracked via a BCH transaction written to the second BCH address. Table 1 illustrates these basic relationships:

TABLE 1

| | |
|---|---|
| BCH Object | Analogy |
| HD wallet | Project |
| First address | Tracks payloads |
| Second address | Tracks metadata |

In step 606, a first encryption key is generated for encrypting blockchain transaction carried data (which is used for tracking payload and metadata storage locations) the blockchain. Also in step 606, a second encryption key may be generated for encrypting stored payload and metadata. As will be understood by one skilled in the art, the encryption keys may be generated according to BIP 32 according to a deterministic incrementing of key generation events. Also, as will be understood in the art, a one-way function may be applied to each encryption key to generate a virtually unlimited number of decryption keys.

The inventors contemplate a use of a greater number of encryption keys than two. In one example, the front-end application and/or the API server selects encryption as a default state for received payload data. By selecting encryption as default, received payloads as well as payload and metadata locations are kept secret by default. In an embodiment, a user may elect to make a payload public. A public payload may be saved to a second payloads address reserved for public-facing data. In an embodiment, the public facing data may provide a public brief description corresponding to secret (payload) content also associated with a project. For example, an inventor or entrepreneur may save trade secret payload data and also save a public-facing brief description of the payload data. In an embodiment, the public-facing brief description is registered to an indexed and crawlable address where it may be discovered by a third party responsive to a search query such as a web search. The public-facing brief description may essentially operate as an offer for license or and offer for sale of the corresponding secret payload data. In an example, the public-facing brief description may describe an input and output of a software module that is saved at a corresponding secret and encrypted address. A third party that wants to use the software module may be provided access to the secret payload data upon agreeing to a use limitation or a license and/or making a payment.

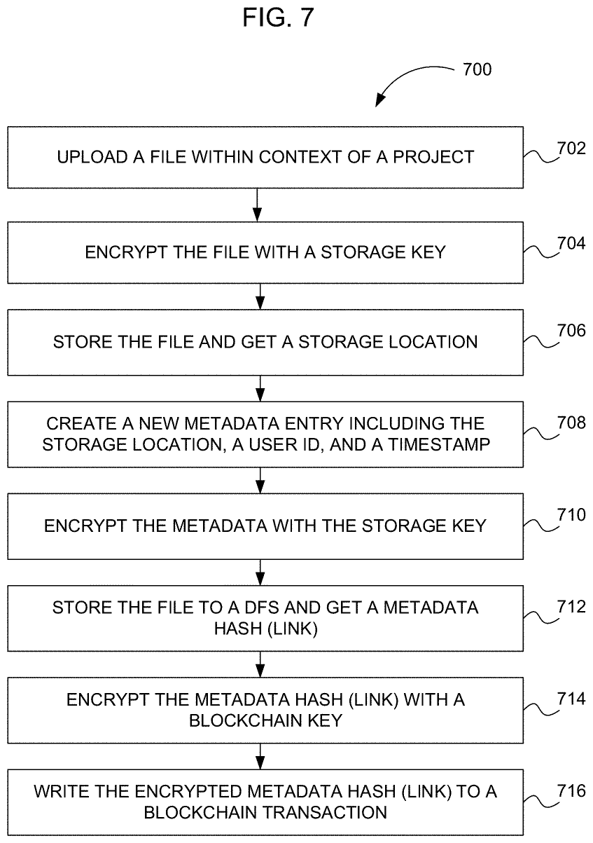

FIG. 7 is a flow chart showing a computer method 700 of payload creation in a project, according to an embodiment.

According to an embodiment, a computer method 700 for creating a new payload includes, in step 702, uploading a file (within context of a project). A payload may be substantially any type of file including text, document, spreadsheet, image, drawing, audio, video, a segment of a stream, etc. In some embodiments, step 702 may optionally include converting the uploaded file to a different file type. For example, a document file or a drawing file may be converted to a format such as .pdf. Optionally, step 702 may include creating counterpart files in different formats. For example, a high-definition video file may be down-converted to a lower definition video file, tele-cine converted to a different format, etc. with each of the original and counterpart files being subsequently saved as respective, related payload instances. In an embodiment, the method 700 may include selecting or making a thumbnail image of a higher resolution file so that the thumbnail image can be saved as a related payload instance. (Alternatively, a thumbnail file may be manually uploaded by the user. In an embodiment, automatic creation of a thumbnail may be selected via the GUI.) For embodiments where counterpart files are generated, subsequent steps in the method 700 may be performed for each counterpart file. Relationships between counterpart files may be tracked by the metadata object.

Step 704 includes encrypting the uploaded file with a payload encryption key such as an IPFS key. Optionally, some or all payloads associated with a project may include remain non-encrypted, such as when public access is intended.

Step 706 may include saving the uploaded and (optionally) encrypted file to the IPFS and getting a payload CID corresponding to the IPFS storage location. Additionally or alternatively, step 706 may include saving the file to a service providing IPFS storage. Additionally or alternatively, step 706 may include saving the file to FileCoin storage (e.g. using FileCoin testnet at the time of this application or FileCoin mainnet when released). For storage that requires funding, step 706 may optionally include transferring an electronic currency value from a user-funded wallet as payment for storage. Alternatively, step 706 may include saving the payload to a uniform resources locator (url) or an Internet Protocol address. For payloads intended to be secret when saved at a url or IP address, it is recommended that the payload be encrypted and saved to a non-indexed and non-crawlable extension that effectively creates a very large address space.

Step 708 includes creating a new metadata entry including the CID. Optionally, the new metadata entry includes a user ID, and a timestamp. Optionally, the new metadata entry includes permission criteria for accessing the payload data. Optionally, the metadata entry includes a group identifier. The group identifier may be used, for example, to segregate matters for different clients such that cross-referencing cannot occur. For example, in an embodiment where the system is used to maintain files for a patent law client, a group identifier corresponding to the client ID may be included in the new metadata entry. Sharing of data with the client may be made as a function of matching the client ID to an account associated with the client. Optionally, a group identifier may be used to automatically select plural projects for sharing with a counterparty, the sharing event being performed for projects matching a specified group identifier.

Optionally, the payload CID received in step 706 may be encrypted using the IPFS key (or optionally, not encrypted) and written to a blockchain as carried data in a transaction having a transaction ID. In cases where the payload CID (or encrypted form thereof) is written to the blockchain, step 708 may include creating a new metadata entry including the transaction ID, the user ID, and the timestamp.

Step 710 includes encrypting the metadata with the IPFS key. Optionally, a third encryption key may be issued for metadata and the metadata may be encrypted with a metadata key. Optionally, step 710 may be omitted and the metadata not be left unencrypted, for example for use cases where public access to the payload data is desired.

Step 712 includes adding the metadata file to the IPFS and getting a metadata CID. The frequency of adding the metadata file to a distributed file system may vary according to system designer preferences. In some embodiments, step 712 occurs every time step 708 occurs. In other embodiments, step 712 may occur at a lower frequency, such as hourly, daily, weekly, or monthly, for example. When there is less than a 1:1 correspondence between metadata entry generation and saving the metadata on the distributed file system, the metadata may be cached in a protected location in the API server or the authorization server (see FIG. 2, for example) and used as needed to access payload data. In some embodiments, a cached version of the metadata is used by default, with earlier versions of metadata being saved as backup snapshots.

Step 714 includes encrypting the metadata CID with a blockchain encryption key. Optionally, such as in the case where public access is intended, step 714 may be omitted.

Step 716 includes writing the encrypted metadata CID to a blockchain. In an embodiment, the encrypted metadata CID is written to the Bitcoin Cash (BCH) blockchain. Additionally or alternatively other blockchains may be used. For example, a private blockchain, permissioned blockchain, an altcoin blockchain or the Bitcoin (BCT) blockchain may be used. For embodiments where more than one blockchain may be used, the identity of the blockchain may be written to a current copy of the metadata as a portion of a new metadata entry.

Payload Creation Protocol

According to an embodiment, when a file is uploaded via a front-end dashboard, (also referred to as a website or web app herein), the file may be converted into an encrypted version and/or altered as described elsewhere herein. Whether encrypted or not, a file stored at a memory location with metadata tracking is referred to as a payload.

In one embodiment, the computer method 700 below allows for easy backup of every piece of data uploaded to the website, while creating a transparent, immutable record of file creation and access, (optionally keeping the content of the information private) with easily controlled access.

According to an embodiment, the computer method 700 for handling a newly uploaded file may include several steps. In step 702, files can be uploaded within the context of a project. Payloads are associated with a project. After the file upload to a back-end server completes, it may trigger an event, which sets off the rest of the steps in the computer method 700. In step 704, after the file-upload-complete event triggers, the file may be encrypted with an IPFS key stored in a Project model. In step 706, the encrypted file may be “added” to an IPFS network, which may generate a link-hash. This may be a cryptographic hash used to uniquely identify the file and retrieve it from the IPFS network. In step 708, a new metadata model may be created to represent this payload and to track access to the file. A minimum amount of information may be required to create a new metadata model.

According to embodiments, the term payloadLink means an IPFS CID for retrieving the payload. The term userIdUpload means the user ID representing the user model in the database (e.g., who uploaded the file). The term createdTimestamp means a JavaScript timestamp representing the time the payload was created.

In step 710, after the new metadata model is created, it may be exported as a JSON object, which may be essentially a text file. This text file may be encrypted with the IPFS key stored in the Project model. In step 712, the encrypted metadata object may also be added to the IPFS network, which will generate another CID. In step 714, the CID for the metadata may be encrypted with the BCH key stored in the project model. In step 716, the encrypted CID for the metadata may be uploaded to the Bitcoin Cash blockchain using the memo-cash protocol (or equivalents) and the memo-push tool (or equivalents).

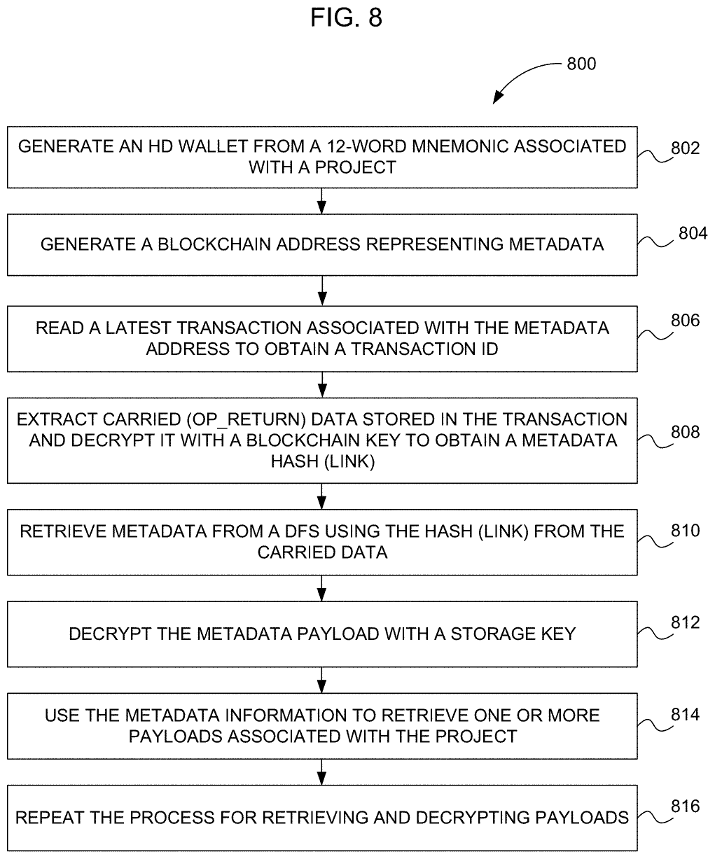

FIG. 8 is a flow chart showing a computer method 800 for payload retrieval, according to an embodiment.

According to an embodiment, a computer method 800 for retrieving a payload includes, in step 802, generating an HD wallet from a 12-word mnemonic associated with a project. Step 804 includes generating a BCH address representing metadata. Step 806 includes getting a latest transaction associated with the metadata address. Step 808 includes extracting OP_RETURN data stored in the transaction and decrypting it with the BCH key. Step 810 includes retrieving the metadata from an IPFS using the hash from the OP_RETURN. Step 812 includes decrypting the metadata payload with the IPFS key. Step 814 includes using the metadata information to retrieve the rest of the payloads associated with the project. Step 816 includes repeating the process for retrieving and decrypting payloads.

Payload Retrieval Protocol

According to an embodiment, all projects, payloads, and metadata may be recreated from data stored on the BCH blockchain and the IPFS network or FileCoin. This may be possible so long as the system has three fundamental pieces of information: (1) the 12-word mnemonic representing the Project, (2) an encryption key/password (if different than a key pair generated by the HD wallet, and (3) the IPFS encryption key/password (if different than a key pair generated by the HD wallet). For embodiments that use asymmetric encryption using the key pair generated by the HD wallet, only the mnemonic is required to access data that remains stored on the DFS (e.g., IPFS and/or FileCoin).

According to an embodiment, the computer method 800 for retrieving and recreating the relationships between payloads includes several steps. Step 802 may include generating an HD wallet using the 12-word mnemonic (representing the Project). Step 804 may include generating the second address for the wallet that represents the metadata. Step 806 may include retrieving the latest transaction associated with the metadata address from a blockchain indexer. Step 808 may include extracting the carried data (e.g., OP_RETURN data) embedded in that transaction and optionally decrypting that data with the decryption key/password. This will result in a cryptographic hash used to retrieve the metadata from the IPFS network. Step 810 may include retrieving the metadata from the IPFS network using the CID from the OP_RETURN data. Step 812 may include decrypting the metadata using the IPFS or HD wallet decryption key/password.

The decrypted metadata may contain all information about payloads and user relationships for the project. Using this data, in step 814, the same retrieval and decryption process can be followed to reconstruct all payload data associated with the project (step 816).

According to an embodiment, reading, from the metadata instance, a payload data storage CID further includes reading, from the metadata instance, at least one blockchain transaction ID corresponding to the corresponding payload data storage instance, and reading, with the server computer, from the blockchain transaction corresponding to the blockchain transaction ID, carried data corresponding to the payload data storage CID.

According to an embodiment, a computer method for driving a graphical user interface (GUI) to present rendered payload data to a user includes causing display, on an electronic display of a user device, a graphical user interface (GUI). The GUI may include a projects region that displays one or more project controls corresponding to one or more respective electronic wallets, and a payload data region that displays one or more payload data controls. The computer method further includes reading, with the server computer from a computer memory, a metadata instance corresponding to the one or more electronic wallets represented by the one or more project controls, and identifying, in the metadata instance, a first storage location in a DFS of first payload data instance holding a thumbnail image corresponding to a second payload data instance. The computer method further includes reading the first storage location of the DFS to obtain the first payload data instance, decrypting the first payload data instance to obtain the thumbnail image, and causing display, with the server computer, of the thumbnail image as at least a portion of a corresponding one of the one or more electronic wallet controls.

According to an embodiment, a computer method for driving a graphical user interface (GUI) to present rendered payload data to a user includes causing display, on an electronic display of a user device, a graphical user interface (GUI). The GUI may include a projects region that displays one or more project controls corresponding to one or more respective electronic wallets, and a payload data region that displays one or more payload data controls. The computer method further includes receiving selection of one or more project controls into a server computer from the user device via the GUI, reading, with the server computer from a computer memory, a metadata instance corresponding to the one or more electronic wallets represented by the one or more project controls, and causing display, with the server computer, of a payload data control in the payload data region of the GUI corresponding to at least a subset of blockchain transactions referenced by the metadata instance. In one embodiment, the payload data region of the GUI includes a subset of the projects region. In another embodiment, the payload data region of the GUI is separate from the projects region.

According to another embodiment, the computer method further includes comparing, with the server computer, a user privilege to at least one blockchain transaction referenced by the metadata instance. Causing display, with the server computer, of a payload data control in the payload data region of the GUI includes indicating payload data controls for which the user has a privilege to see corresponding payload data instances. For example, a non-viewable payload control may be grayed out and made non-selectable. Alternatively, a viewable payload control may be bolded, thumbnailed, or otherwise highlighted.

According to another embodiment, the computer method further includes comparing, with the server computer, a user privilege to at least one blockchain transaction referenced by the metadata instance. Causing display, with the server computer, of a payload data control in the payload data region of the GUI includes selecting for display only payload data controls for which the user has a privilege to see corresponding payload data instances.

According to another embodiment, the computer method further includes receiving selection, into the server computer from the user device via the GUI, of a payload control, reading, from the metadata instance, the at least one blockchain transaction ID corresponding to at least one previous blockchain transaction, and causing indication, in the GUI, that a payload data instance corresponding to the selected payload control corresponds to a valid blockchain transaction.

According to another embodiment, the computer method further includes receiving selection, into the server computer from the user device via the GUI, of a payload control, reading, from the metadata instance, the at least one blockchain transaction ID corresponding to at least one previous blockchain transaction, and reading a carried data value (e.g., an OP_RETURN value) carried by the blockchain transaction corresponding to the blockchain transaction ID. The computer method further includes reading, from a data storage location corresponding to the carried data value, payload data corresponding to the payload control, and causing expression, on the user device, of the payload data corresponding to the payload control.

According to another embodiment, the computer method further includes receiving selection, into the server computer from the user device via the GUI, of a payload control, and reading, from the metadata instance, a data storage location corresponding to payload data corresponding to the payload control. The computer method further includes reading, from the data storage location, the payload data, and causing expression, on the user device, of the payload data corresponding to the payload control.

According to another embodiment, the computer method further includes receiving selection, into the server computer from the user device via the GUI, of a payload control, reading, from the metadata instance, the at least one blockchain transaction ID corresponding to at least one previous blockchain transaction, and reading a carried data value (e.g., an OP return value) carried by the blockchain transaction corresponding to the blockchain transaction ID. The computer method further includes reading, from a data storage location corresponding to the carried data value, an earlier metadata object corresponding to a time when the payload data was saved, reading, from the earlier metadata object, a payload data storage location corresponding to the selected payload control, reading, from the payload data storage location, the payload data, and causing expression, on the user device, of the payload data corresponding to the payload control.

According to another embodiment, the computer method further includes receiving selection, into the server computer from the user device via the GUI, of a payload control, reading, from the metadata instance, the at least one blockchain transaction ID corresponding to at least one previous blockchain transaction, and reading a carried data value (e.g., an OP return value) carried by the blockchain transaction corresponding to the blockchain transaction ID. The computer method further includes reading, from a data storage location corresponding to the carried data value, an earlier metadata object corresponding to a time when the payload data was saved, reading, from the earlier metadata object, a payload data storage location corresponding to the selected payload control, reading, from the payload data storage location, the payload data, and causing expression, on the user device, of the payload data corresponding to the payload control.

According to another embodiment, the computer method further includes decoding the carried data value to determine the data storage location. The data storage location may include a uniform resource locator (URL), an Internet Protocol address, or a distributed file system (DFS) CID.

According to an embodiment, a computer method for providing immutable proof of prior data existence includes driving a graphical user interface (GUI) on an electronic display of a user device to present a create-project control or menu, receiving, into an application program running on hardware, actuation of the create-project, and responsively to receiving actuation of the create-project, causing an electronic wallet to be created. The computer method includes causing a payload address and a metadata address to be generated from the electronic wallet, generating two decryption keys, a blockchain decryption key and a storage decryption key, causing a metadata instance to be created at the metadata address, and causing a project control corresponding to the electronic wallet to be displayed in the GUI. The electronic wallet may include a hierarchical deterministic (HD) wallet generated from a mnemonic, and further may include causing the mnemonic to be saved to an authorization server. In one embodiment, the computer method further may include saving the keys to the authorization server. The decryption keys may include respective symmetric encryption keys. Additionally and/or alternatively, the decryption keys may include respective asymmetric encryption keys, and instances of encrypting the metadata and payload data may include generating encryption keys from the decryption keys according to a one-way hyperbolic function.

According to another embodiment, the computer method further may include establishing a current electronic wallet, receiving designation of a file for upload into the server computer, receiving the designated file, and saving a payload data corresponding to the designated file to a payload storage location. The computer further may include writing the payload storage location to the metadata instance, creating a display list, in part, by reading the metadata instance, and causing the GUI to display a payload control corresponding to the payload data. Establishing a current electronic wallet may include receiving selection of a project control. Additionally and/or alternatively, establishing a current electronic wallet may include holding a new electronic wallet as the current electronic wallet.

According to another embodiment, the computer method may further include receiving, via the GUI into the server computer, a designation that the file for upload is intended to be public. Saving the payload data corresponding to the designated file to a storage location may include saving a non-encrypted version of the file to the storage location.

According to another embodiment, the computer method may further include receiving, via the GUI into the server computer, a designation that the file for upload is intended to be private. Saving the payload data corresponding to the designated file to a storage location may include saving an encrypted version of the file to the storage location.

According to another embodiment, the computer method may further include encrypting the designated file with a storage encryption key prior to saving the payload data.

In one embodiment, saving the payload data corresponding to the designated file to the payload storage location may include storing the payload data in a distributed file system (DFS). Storing the payload data in a DFS may include storing the payload data in an Interplanetary File System (IPFS). Additionally and/or alternatively, storing the payload data in a DFS may include storing the payload data using FileCoin. In another embodiment, saving the payload data corresponding to the designated file to the payload storage location may include storing the payload data at a uniform resource locator (URL) address or an internet protocol (IP) address.

According to another embodiment, the computer method further includes taking a hash of the payload data, and recording data corresponding to the hash of the payload data as carried data in a blockchain transaction to provide subsequent verification that the file is as originally uploaded with no subsequent modification.

In one embodiment, writing the payload storage location to the metadata instance includes creating a new metadata entry including a user ID, a timestamp, and the storage location.

According to another embodiment, the computer method further includes encrypting the metadata with the storage key and storing the encrypted metadata at a DFS CID location while maintaining a current copy of the metadata or encrypted metadata at the metadata address. The computer method further includes encrypting the metadata CID with a blockchain encryption key, recording the encrypted metadata CID as carried data in a blockchain transaction identified by a new transaction ID, and writing the new transaction ID to the current metadata. In one embodiment, storing the encrypted metadata at a DFS CID location is performed upon completion of writing the payload storage location to the metadata instance. In another embodiment, storing the encrypted metadata at a DFS CID location is performed upon expiration of a time interval since a previous instance of storing the encrypted metadata at a previous DFS CID. Past instances of metadata stored at respective past instances of DFS CIDs may provide indelible proof of existence of payload data hashes.

According to another embodiment, the computer method further includes creating a thumbnail image corresponding to the payload data. Causing the GUI to display a payload control corresponding to the payload data may include causing the GUI to display the thumbnail image as at least a portion of the payload control. The computer method may further include storing the thumbnail image at a thumbnail storage location, and writing the thumbnail storage location to the metadata instance.

In one embodiment, the metadata instance includes a JavaScript Object Notation (JSON) object. In another embodiment, the metadata instance includes a YAML object. Additionally and/or alternatively, the metadata instance includes an Extensible Markup Language (XML) object. The metadata instance may include a Comma-separated values (CSV) object.

As use herein, the term blockchain may refer to a public or private blockchain, permissioned or open, using various types of proofs including proof-of-work and proof-of-stake. According to embodiments, a blockchain referenced herein may be describing the Bitcoin Cash (BCH) blockchain. As used herein, the term IPFS refers to the Interplanetary File System, which is a medium for transmitting immutable data in a format that is easy to backup and difficult to censor. The term distributed file system or DFS may be used to refer to a generic networked file system that operates without a need for a global file allocation address. For ease of understanding, the term DFS may be replaced by IPFS herein. Depending on system preferences, IPFS may be networked across the global IPFS network, such that back-up is automatically performed as the IPFS protocol causes the file to be copied to other IPFS nodes. Alternatively, the term IPFS may refer to a stand-alone or a sequestered network of IPFS, which may exist, for example, behind a network firewall. As use herein, the term CID refers to a content identifier. A CID used to retrieve files from the IPFS network. It is both a ‘link’ (in the sense of an HTML hyperlink) to the content, but also a unique fingerprint (e.g. a ‘hash’, more specifically a multi-hash) of the document. A CID may be referred to as, and may be considered synonymous with, a hash-link. As used herein, the term payload database model refers to metadata referencing one or more payload files. Accordingly, the terms metadata and payload database model may be considered synonymous, although use herein may be selected to clarify certain processes. Strictly speaking, a payload database model is “exported” to a JSON file to form a metadata file, but the payload database model is then carried by the metadata file in subsequent operations.

As use herein, the term counterparty refers to another User that a payload or a project is shared with. Sharing with a counterparty may be in the spirit of generating a business agreement, according to an embodiment.

Project Creation Protocol

According to embodiments, the most fundamental primitive in this protocol is the project. Every payload and piece of Metadata is associated with a Project. payloads and their Metadata are not allowed to exist without being associated to a project.

Users may be assigned to a project, but exist independently of projects. Users interact with payloads and this interaction is recorded in the Metadata.

When a new root project is created, a new 12-word mnemonic is received or generated and assigned to it. the 12-word mnemonic (or is some cases a 24-word mnemonic) is the basic information used to create a HD wallet, such as a Bitcoin Cash (BCH) HD wallet, according to the specification BIP44. Alternative wallets may be used in other embodiments. The public key can generate a unique wallet address, such as a BCH address. The wallet address is used to uniquely identify projects and payloads.

HD Wallets

According to an embodiment, the HD wallet for each project is adapted from the BIP44 specification for cryptocurrency wallets. Addressing uses the format:
m/44′/145′/0′/n,

where “n” is an index that may be assigned to designate a new subfolder within the HD wallet.

The above may be used for the root derivation for the project. The derivation is used to generate a private-public key pair, which is then used to generate a blockchain wallet (also referred to as Bitcoin Cash address). According to an embodiment, the public key is the identity of the Bitcoin Cash address. The wallet address is used to identify the Project uniquely and globally.

The public key of the Project may be used to encrypt all data associated with Payloads and Metadata written to IPFS and the BCH blockchain. The corresponding private key may be used to decrypt all data encrypted with the public key.

Encryption

According to an embodiment, by default, Payloads, their Metadata, and the CIDs to that content, are encrypted using the public key of the Project or sub-project they are associated with. Any data written to the blockchain or shared via IPFS is indecipherable without the private key, generated from the 12-word mnemonic, which is stored in a Project database model. The project database model may also be referred to as metadata. In other embodiments, default behavior may include not encrypting some or all of the payloads, metadata, and CIDs.

Private-Public key pairs and the use thereof may be referred to as asymmetric encryption. In asymmetric encryption, the public key may be used to encrypt data and the private key may be used to decrypt data. The encryption is asymmetric because a different key (or password) is used to encrypt data than to decrypt data. Approaches for verifying wallets by presenting digital challenges, for providing unidirectional and bidirectional transmission of encrypted data, and other processes using asymmetric encryption may be known to those skilled in the art.

In alternative embodiments, some or all of the encryption and decryption referenced herein may be embodied as symmetric encryption. In symmetric encryption a single password (or key) is used to encrypt and to decrypt data.

In alternative embodiments, some or all of the encryption and decryption referenced herein may be omitted such that metadata, CIDs, and associated payload is available in unencrypted form.

In an embodiment, a user having appropriate credentials may post unencrypted payload data in a project if it is desirous to provide a form of public-facing overview of the project, while keeping details of payload data secret. This may be used, for example, to provide a searchable record of the project that may be used by a searcher to make an inquiry about the project. The user may then make successively more secret information available to the searcher as warranted by business and security concerns. In another embodiment, payloads within a project may be kept secret while a group works and posts to the project, then one or more of the payloads associated with the project may be released to the public as unencrypted data by writing the selected unencrypted payload data to IPFS and posting the unencrypted CID to the project.

Payload Creation Protocol

According to an embodiment, when a file is uploaded via a web-based user interface (UI), the file gets converted into a payload. A payload may be encrypted, stored in IPFS, and the payload CID written to a metadata file. The metadata file is encrypted and stored in IPFS. The metadata CID may be encrypted and written to the blockchain. According to an embodiment, the encrypted payload CID may optionally be written to the blockchain, for example when a user selects “Certification” of the payload via the UI. The Certification may optionally be provided at a cost to the user.

According to embodiments, the payload creation protocol achieves the following objectives:
Easy backup of every piece of data uploaded to the website.
Create a transparent, immutable record of file creation and access.
Keep the content private, with easy access control.

The following steps describe the process for handling a newly uploaded file:

Files may be uploaded within the context of a project. Payloads must be associated with a project. After the file upload to the back-end server completes, it triggers an event, which sets off the rest of the steps in this process.

After the file-upload completes, a SHA256 cryptographic hash ‘fingerprint’ is generated from the original file and saved to the Payload database model (aka, the Metadata). This fingerprint is used to prove authenticity at a later date.

The original file is then encrypted with the public key of the project (or sub-project) the Payload is associated with.

The encrypted file is added to IPFS, which will generate a payload CID. The payload CID is used to uniquely identify the payload, ensure its authenticity, and retrieve the payload from the IPFS network.

A payload database model is generated that contains the SHA256 hash, the payload IPFS CID, access records, and other data directly associated with the payload. The payload database model is exported into a JSON object. The payload database model and the JSON object are referred to as metadata.

The metadata is encrypted with the public key of the project (or sub-project) and uploaded to IPFS. Uploading the metadata generates a metadata CID.

The metadata CID is encrypted with the public key of the project (or sub-project) and published to the blockchain at the project address. The blockchain entry may follow the PS001 Media Sharing Protocol.

In one embodiment, the metadata is recorded as a stand-alone JSON file which tracks a particular payload. Metadata for all payloads in a project may be reconstructed by reading a history of transactions associated with the project address, where each transaction returns an encrypted CID that accesses a then-current state of a particular JSON file corresponding to the particular payload. In another embodiment, metadata associated with each payload in a project is appended to a project-level JSON file. Reading a transaction associated with the project address, in this case, returns and encrypted CID that accesses a then-current state of a project-level JSON file that carries metadata for at least all then-current payloads in the project.

Periodically and/or when a tracked action occurs, a ‘snapshot’ of the metadata is recorded. For instance, when a payload is shared with counterparties, the sharing events are written to the metadata JSON file. A sharing event also generates access control permissions, which are also written to the JSON file. Viewing events are similarly written to the JSON file. The snapshot of a modified JSON file is appended to the transaction history of the (BCH) address associated with the project and serves as an append-only log to track snapshots over time.

While references to the Bitcoin Cash (BCH) blockchain is used herein, it shall be understood that description may be applied to alternative blockchains. According to embodiments, computer methods described herein may be useful for use with blockchains that track transactions via blockchain states, such as Ethereum and derivatives thereof. Additionally or alternatively, computer methods described herein, and equivalents thereof, may be applied to an unspent transaction output (UTXO) blockchain with a memo field, description, OP_RETURN, or other carried data field having sufficient capacity to carry or refer to a CID. The field name OP_RETURN, shall be understood to refer to a carried data field in any blockchain to which the herein described computer methods are applied, regardless of what the field is named.

According to embodiments, computer methods described herein may be especially useful for use with a blockchain indexer that maintains, rather than prunes, the OP_RETURN fields in past transactions. To this end, an Indexer referenced to a periodically incremented volume (interval of blockchain transactions) may be useful for reducing database size constraints that might otherwise make transaction pruning difficult to avoid.

Payload Retrieval

According to an embodiment, project, payload, user, and metadata information may be stored locally, for example on a Mongo database and a local IPFS node. For normal operations, data from Mongo may be used to minimize lag time and maximize responsiveness to user input. According to embodiments, the project, payload, user, and metadata is also written to IPFS and the blockchain using the payload creation protocol described above.

In the event of a catastrophic failure, to boot a new instance of the system or introduce a new server, to recover from any malicious attack, or if an audit is requested, all information may be reconstructed using a project reconstruction protocol described below.

Project Reconstruction Protocol

All projects, payloads, and metadata may be recreated from data stored on the blockchain and the IPFS network. This is possible so long as the system has one fundamental piece of information:

The 12-word mnemonic representing each Project.

The protocol for retrieving and recreating the relationships between Payloads is as follows:

Generate an HD wallet using the 12-word mnemonic (representing the Project).

Derive one or more key pairs and one or more addresses corresponding to the HD wallet.

Retrieve blockchain transaction histories associated with the addresses generated by the HD wallet.

Extract carried data, which in an embodiment is the OP_RETURN data embedded in the latest transaction, for each address with a transaction history. Decrypt the OP_RETURN data with the password or private key of the project to obtain a metadata CID.

Retrieve the metadata from the IPFS (or FileCoin) network using the decrypted metadata CID.

Decrypt the metadata using the password or private key of the project.

The decrypted Metadata contains all information about each payload in the project, and user relationships for each payload.

Using this data, the payload reconstruction process may be used to retrieve and decrypt payloads associated with the project.

Although payloads are described herein as referring to single, specific files maintained by the system, it will be understood that plural files may be appended to form a single payload. For example, a plurality of payloads may be combined into a self-unarchiving compressed file that carries the plurality of payloads. Depending on a system use or a user preference, the combined payloads may be displayed to the user as individual payloads as respective controls or items in a list in a GUI, or the combined payloads may be displayed to the user as a single payload instance. When displayed as a single payload instance, an control representing the combined payloads may be designed to indicate to the user that clicking on the control will result in a display of an control corresponding to each of the combined payloads or directly in the display of each of the combined payloads.

According to embodiments, user access is tracked using the metadata model described above. Accessed may be tracked on a per-payload basis and/or on a per project basis. As indicated above, the terms ‘Metadata’ and ‘Payload model’ are used interchangeably. The metadata is a local database model describing the payload.

The metadata may include a fileAccess property that is an array of objects. Each object contains a timestamp, user ID, and the action performed by the user. Examples of file access objects are given below, where the timestamp is a Unix timestamp. In this example, one user, corresponding to a user ID “6058a50a6fb007487ce95fb6” first viewed, then downloaded, then again viewed a payload, where each record is appended to the end of previous file access records.

```
″fileAccess″: [
  {
    ″timestamp″: 1616422430,
    ″userId″: ″6058a50a6fb007487ce95fb6″,
    ″action″: ″view″
  },
  {
    ″timestamp″: 1616422455,
    ″userId″: ″6058a50a6fb007487ce95fb6″,
    ″action″: ″download″
  },
  {
    ″timestamp″: 1616422478,
    ″userId″: ″6058a50a6fb007487ce95fb6″,
    ″action″: ″view″
  }
]
```

A permission for a user to access a payload is recorded in a sharedWith array in the metadata. The objects in the sharedWith array track the other users that have had the payload shared with them, but it does not track permissions for accessing the Payload.

```
″sharedWith″: [
  {
    ″email″: ″userr@gmail.com″,
    ″id″: ″6058a6932efdb04b0e9d7d56″,
    ″isShadowUser″: false
  }
]
```

Access control permissions to a payload may be defined in a sharedPermissions array. The objects in the sharedPermissions array may define a ‘matrix’ of permissions. Each user and payload fall within the sharedPermissions matrix. Below are example axes of the matrix including available values:

User Role: owner, admin, can-download, view-only.

Accessibility: public (not encrypted), private (encrypted, default).

Time Limit: no limit, 30 days, 24 hours, custom.

Payload state: active, archived, deleted.

Sharing permission: yes, no

An example of the sharedPermissions array in the metadata for an example payload is shown below:

```
″sharedPermissions″: [
  {
    ″email″: ″user1@userland.com″,
    ″userId″: ″6058a50a6fb007487ce95fb6″,
    ″shareLevel″: 20,
    ″shareLevelText″: ″view-only-time-based″,
    ″shareEndDate″: 1619014652,
    “sharingPermission”: no
  },
  {
    ″email″: ″user2@userland.com″,
    ″userId″: ″6058a50a6fb007487ce95fb7″,
    ″shareLevel″: 30,
    ″shareLevelText″: ″can-download″,
    ″shareEndDate″: 1619015421,
    “sharingPermission”: yes
  }
],
```

The shareLevel parameter indicates how the user may interact with the payload. For example, in a share level 20 instance, the user 6058a50a6fb007487ce95fb6 may view the payload, for example as a .pdf file displayed on the user's screen, but may not download the actual file. This may provide a measure of security in that the user 6058a50a6fb007487ce95fb6 cannot download the payload in its native file format, such as .docx for example, and freely use or modify the payload.

According to an embodiment, a view-only file is watermarked prior to display, and the watermark value recorded in the file access history. The watermark may be embedded in the document via steganography in such a way that the user 6058a50a6fb007487ce95fb6 knows the file is watermarked, but does not know how to remove the watermark. If the user 6058a50a6fb007487ce95fb6 wishes to access the original file, the user 6058a50a6fb007487ce95fb6 may request an upgrade in share level from the owner or admin of the project.

The shareEndDate sets a date and time when the viewing privilege expires. This may be used, for example, when a payload author seeks review from user 6058a50a6fb007487ce95fb6, but does not wish for the user to have indefinite access to what may be sensitive information. For example, if a user wishes to share a sensitive medical record with a specialist physician or health care practitioner sufficient to receive treatment, but does not wish for the physician or practitioner to continue to have access when the treatment is anticipated to be over, the user may set an expiration date on the shared data, which causes the shareEndDate to be set.

In another example shown in the illustrative shared Permissions array, the same payload may be shared with a second user, 6058a50a6fb007487ce95fb7, according to a “can-download” term. For example, a user 6058a50a6fb007487ce95fb7 having a “can-download” status may download the original payload (or a watermarked version of the original payload) in its native format. This may be useful when the owner of the payload wishes to collaborate with the user 6058a50a6fb007487ce95fb7 and seeks revision of the original document. The “can-download” parameter may additionally or alternatively used when the payload is a machine-readable payload that needs to be in its original format to be useable by the user 6058a50a6fb007487ce95fb7. For example, if the payload is an output file from a 3-D or tomographic scan, the user 6058a50a6fb007487ce95fb7 may need the output file in its original format to view or otherwise use the payload. Similarly, if the payload is a driver file for a device such as a CNC machine, a 3D printer, a computer plotter, etc., the shareLevel “can-download” parameter may be used to deliver the payload for its intended use.

Project Creation

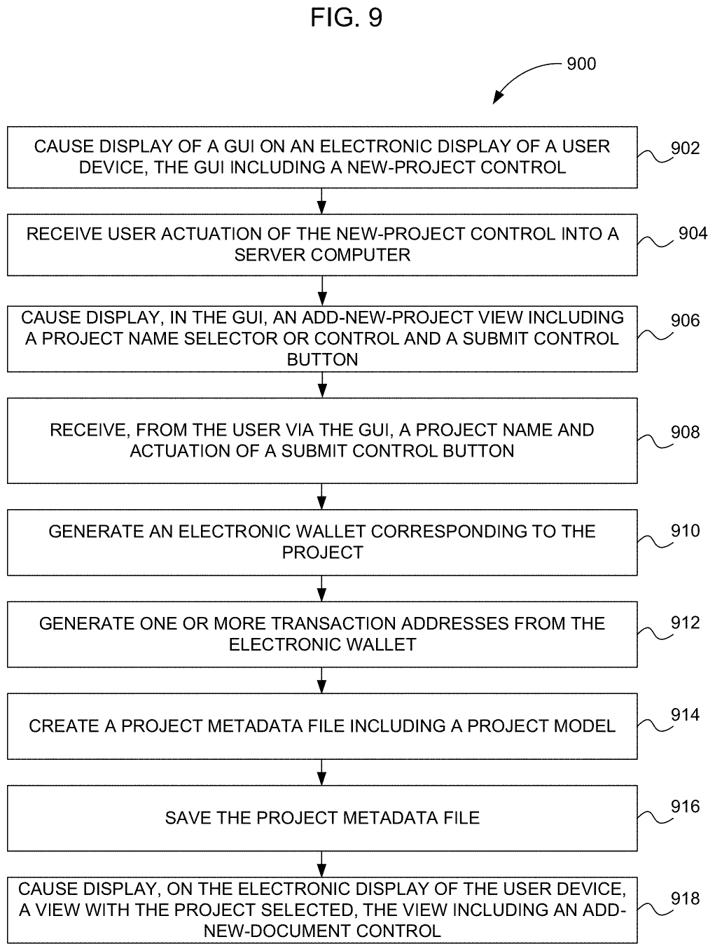

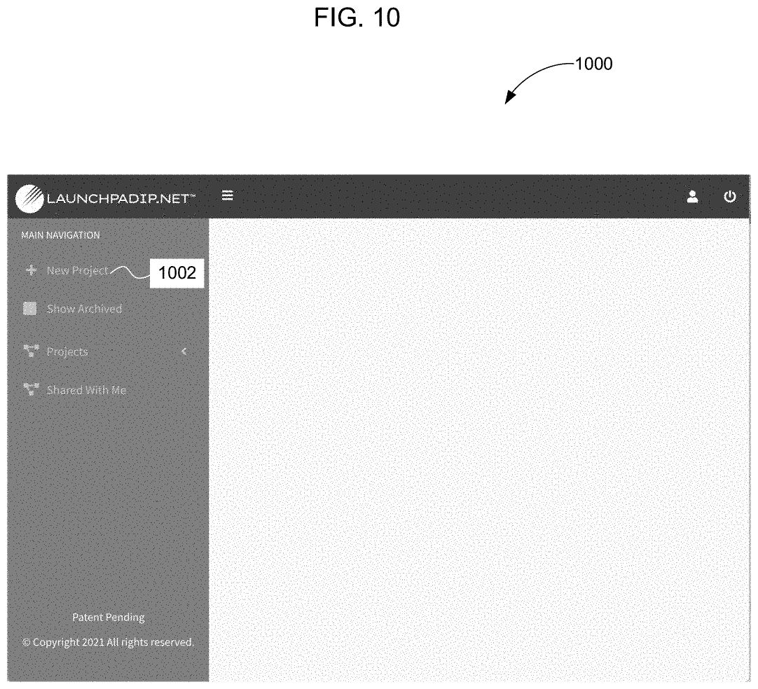

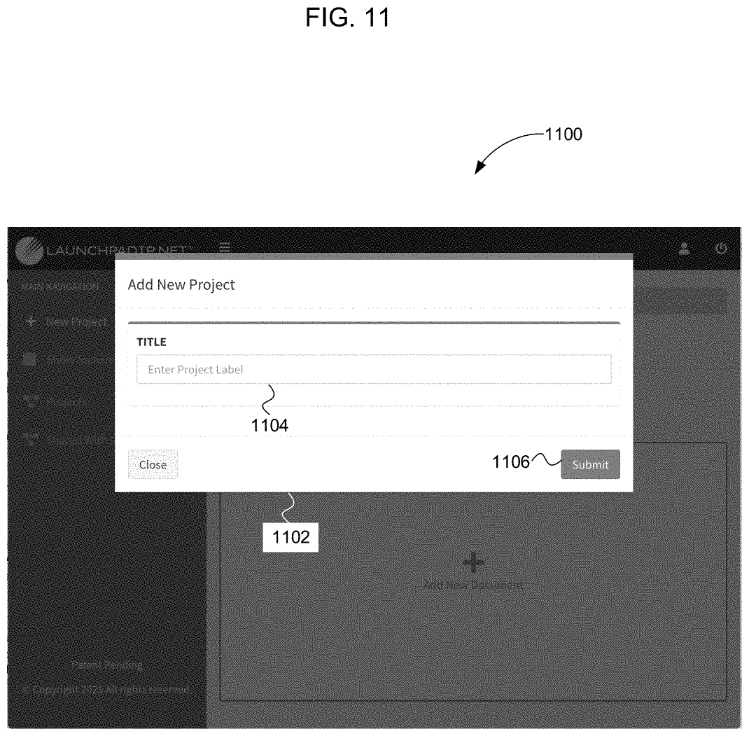

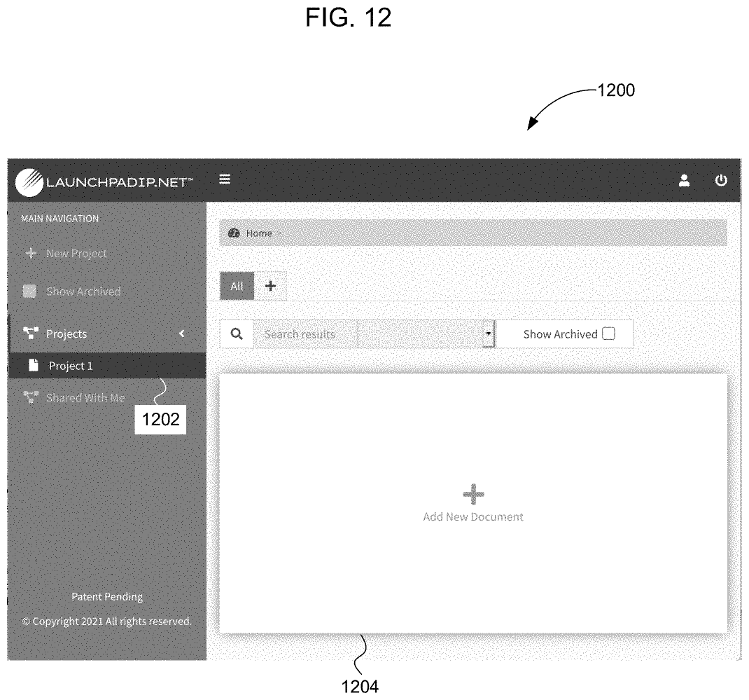

FIG. 9 is a flow chart showing a computer method 900 for creating a project corresponding to an electronic wallet, according to an embodiment. FIG. 10 is a view of a graphical user interface (GUI) 1000 including a new project control 1002 referenced in the computer method 900 of FIG. 9, according to an embodiment. FIG. 11 is a view of a GUI 1100 referenced in the computer method 900 of FIG. 9, according to an embodiment. The GUI 1100 shows an add-new-project view 1102 including a project name selector control 1104 and a submit control button 1106, according to an embodiment. FIG. 12 is a view of a GUI 1200 that results from the computer method 900 of FIG. 9, according to an embodiment. The view 1200 includes an add-new-document control 1204 in the context of a selected project 1202, according to an embodiment.

According to an embodiment, referring to FIG. 9 in view of FIGS. 10-12, a computer method 900 for creating a project includes a computer method 900 for establishing an electronic wallet for registering authenticity of a payload using a blockchain transaction. The method 900 includes, in step 902, causing display, on an electronic display of a user device, a graphical user interface (GUI) 1000, the GUI including a new-project control 1002 and, in step 904, receiving, into a server computer operatively coupled to the GUI, a user actuation of the new-project control 1002. The method proceeds to step 906, which includes causing display, in the GUI 1100, an add-new-project view 1102 including a project-name control 1104 for receiving entry or designation of a project name and a submit control button 1106 for creating the project and, in step 908, receiving, from the user via the GUI 300 a project name (illustrated herein as “Project 1”) via the project-name control 1104 and a command for creating the project via the submit control button 1106.

Step 910 includes generating an electronic wallet corresponding to the project. According to an embodiment, generating the electronic wallet corresponding to the project includes generating a hierarchical deterministic (HD) wallet. Generating a HD wallet may include generating a mnemonic, such as a 12-word mnemonic. Optionally, the mnemonic may be displayed to the user in a GUI view. Alternatively, generating a HD wallet may include receiving a mnemonic, such as a 12-word mnemonic, from a user via a GUI control.

Proceeding to step 912 the method 900 includes generating one or more transaction addresses from the electronic wallet, each generated address being characterized by a respective private-public key pair. In one embodiment, generating one or more transaction addresses from the electronic wallet in step 912 includes generating two addresses. One transaction address may be designated for having payload transactions referenced to it and a second transaction address may be designated for having metadata transactions referenced to it. In another embodiment, generating one or more transaction addresses from the electronic wallet includes generating one address wherein the generated transaction address is designated for having metadata and payload transactions referenced to it.

Step 914 includes creating a project metadata file including a project model. For example, creating a project metadata file including a project model includes creating a project model including a (12-word) mnemonic corresponding to a root for the HD wallet corresponding to the project. In an embodiment, the project metadata file is a JavaScript Object Notation (JSON) file. In step 916, the project metadata file may be saved in a database (such as MondoDB) accessible by the server computer.

In an embodiment, the project metadata file may be encrypted, followed by writing the encrypted project metadata file to a distributed file system (DFS) such as IPFS, receiving a project metadata CID; and broadcasting a blockchain transaction including the project metadata CID (or an encrypted version thereof) as carried data.

The method 900 proceeds to step 918, which includes causing the GUI to display a view 1200, shown in FIG. 12, with a project control corresponding to the new project 1202 selected, the view 1200 including an add-new-document control 1204.

In an embodiment, the method 900 includes receiving, into the server computer, actuation of the add-new-document control 1204 from the user via the GUI; and responsive to actuation of the add-new-document control 1204, interacting with the user via the GUI to create a new payload referenced to at least one of the one or more addresses generated from the electronic wallet.

According to an embodiment, a non-transitory computer readable medium carries instructions for causing a computer to execute the method 900.

Upon the completion of the method 900 or at a later date, a payload may be created, the payload being referenced to the electronic wallet corresponding to the project.

Payload Creation

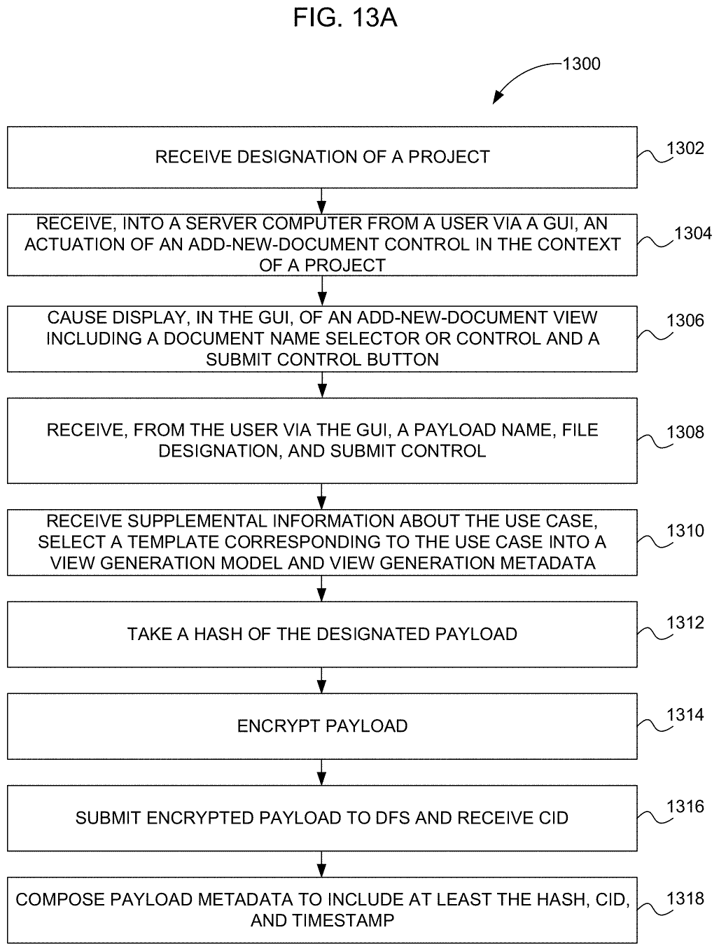

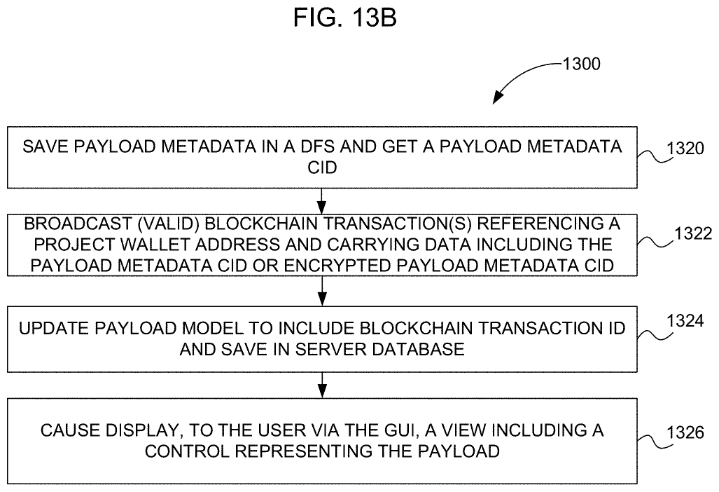

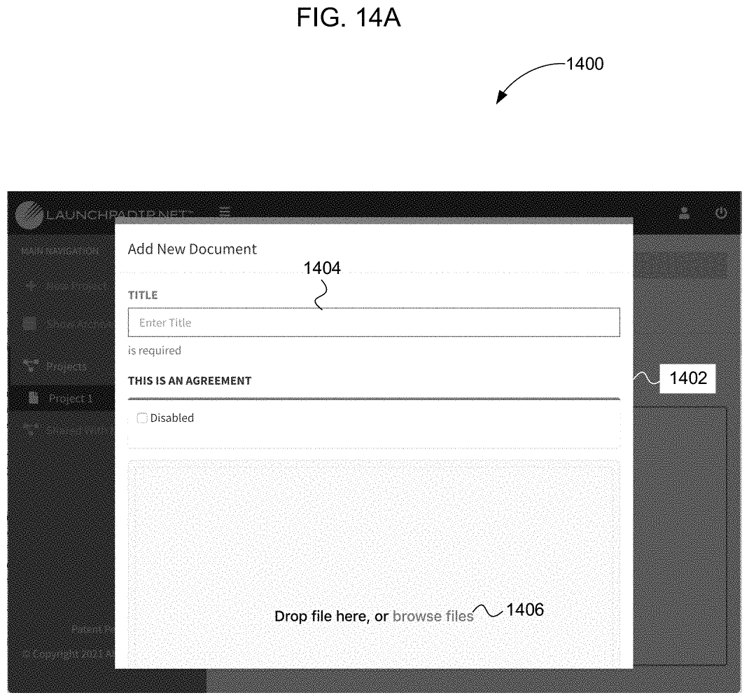

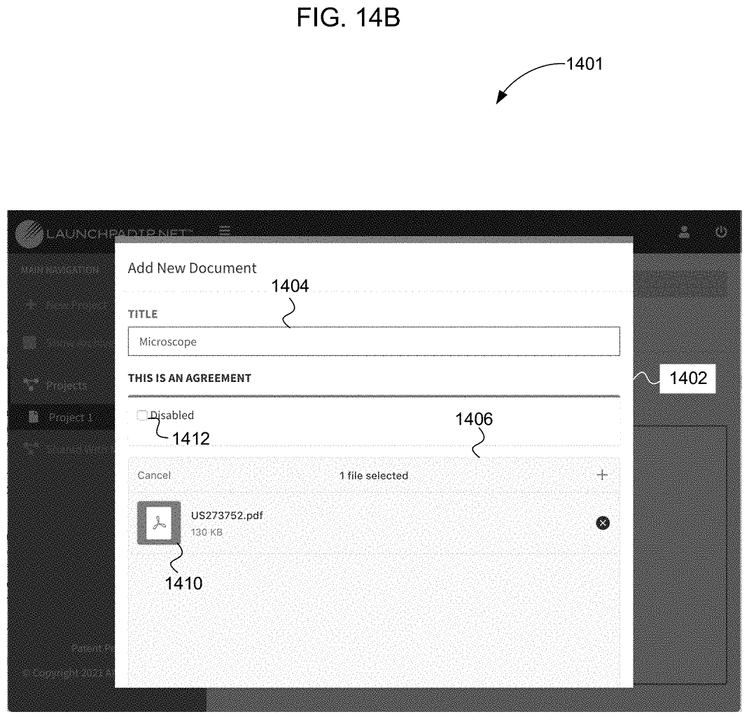

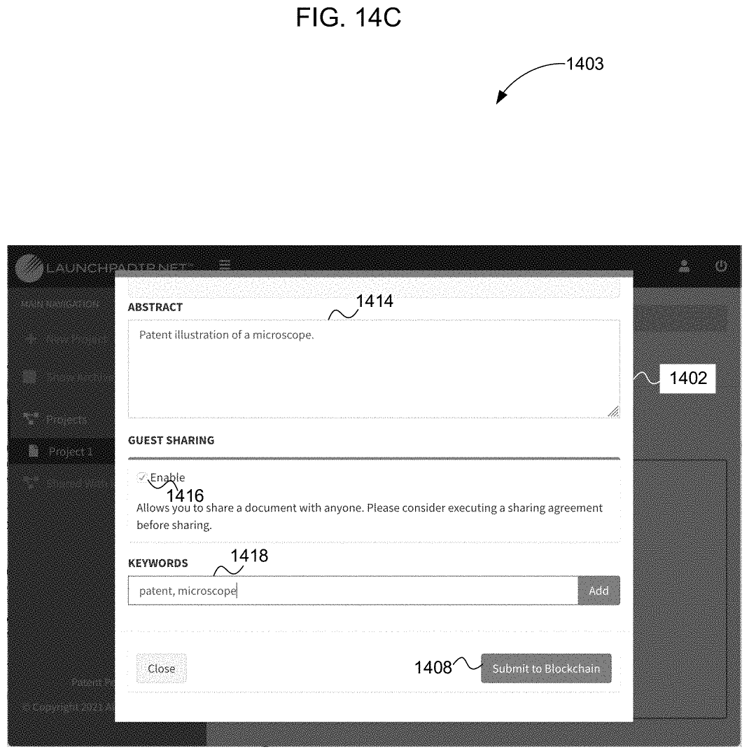

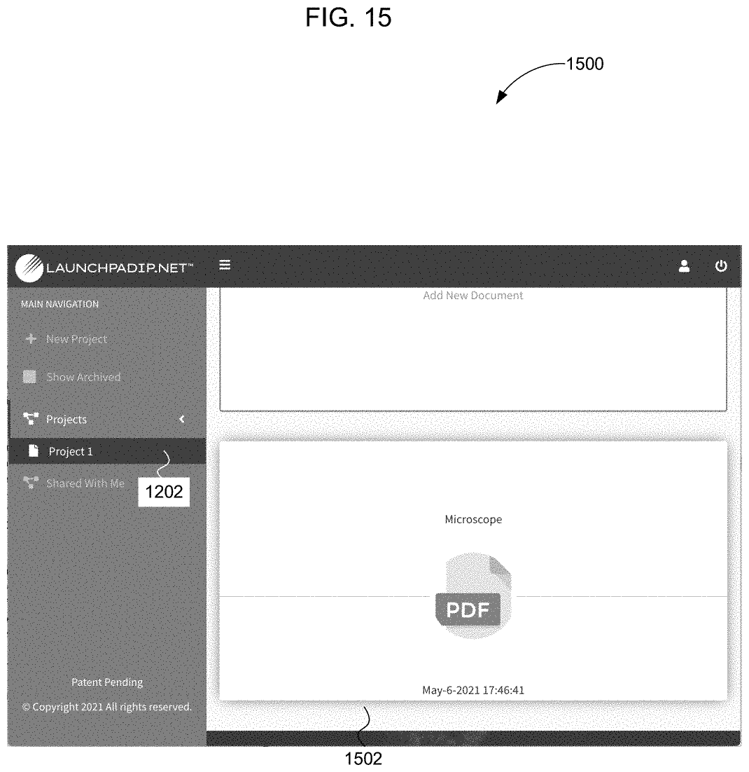

FIG. 13A is a flow chart showing a portion of a computer method 1300 for creating a payload associated with the selected project 1202 of FIG. 12, according to an embodiment. FIG. 13B is a flow chart showing another portion of the computer method 1300 for creating the payload associated with the selected project 1202 of FIG. 12, according to an embodiment. FIG. 14A is a view of a GUI 1400 including an add-new-document view 1402 including a payload title control 1404, and a file selector 1406, according to an embodiment. FIG. 14B is a view 1401 of the GUI including the add-new-document view 1402 of FIG. 14A with the title inserted and a file 1410 entered, according to an embodiment. FIG. 14C is a view 1403 of the GUI 1400, 1401 including the add-new-document view FIGS. 14A and 14B showing another portion of the add-new document view 1402, according to an embodiment. FIG. 15 is a view of a GUI 1500 including a selected project 1202 and a payload control 1502, according to an embodiment.

According to an embodiment, referring to FIGS. 13A and 13B in view of FIGS. 12, 14A, 14B, 14C, and 15, a computer method 1300 for creating a payload includes computer method 1300 for registering authenticity of one or more computer files. In an embodiment, the method 1300 includes the steps of receiving, into a server computer from a user via a graphical user interface (GUI), an action corresponding to designation of at least one computer file 1410 for registering authenticity in the context of a project electronic wallet. Embodiments corresponding to designating at least one computer file 1410 for registering authenticity are described below. In other embodiments, the designation may be made by a front-end application as an action embedded therein.

In an embodiment, the method 1300 begins with step 918, including causing display, on an electronic display of the user device, the graphical user interface (GUI) 1200 including a project selector control 1202 and an add-new-payload control 1204, then, in step 1304, receiving, from a user via the GUI into the server computer, actuation of the add-new-payload control 1204. Responsively, the server computer, in step 1306 causes display, in the GUI 1400, 1401, 1403 (FIGS. 14A, 14B, and 14C), of an add-new-payload view 1402, the add-new-payload view 1402 including a document name control 1404, a file selection control 1406, and a submit-to-blockchain control button 1408. The method 1300 may include (referring to step 918 in FIG. 9) causing display, on an electronic display of the user device, the graphical user interface (GUI) 1200 including a project selector control 1202 and an add-new-payload control 1204 and, in step 1302, receiving designation, from a user via a GUI into the server computer, of the project selector control 1202 corresponding to the electronic wallet.

The method 1300, in an embodiment, includes receiving, into the server computer from the user via the graphical user interface (GUI), the action corresponding to designation of the at least one computer file 1410, in step 1304, may include receiving actuation of the document name control 1404, actuation of the file selection control 1406, and actuation of the submit-to-blockchain control button 1408.

According to an embodiment, the method 1300 may include step 1310, wherein the server computer receives, from the user via the GUI 1400, 1401, 1403, supplemental information about the payload. In an embodiment, the add-new-payload view 1402 includes a control 1412 for designating the computer file as an agreement for governing uses of a related payload. The add-new-payload view 1402 may include an abstract control 1414 for receiving, from the user, an abstract describing what a designated document 1410 is. The add-new-payload view 1402 may include a sharing control 1416 for receiving, from the user, an input indicating whether a counterparty with whom the payload is to be shared may further share the payload with another party. (Sharing is described elsewhere herein.) The add-new-payload view 1402 may include a keywords control 1418 for receiving, from the user, terms associated with the designated document 1410 that may be used as metadata for searching for a payload created from the designated document 1410. Other controls are contemplated, depending on use-case.

The method 1300 may include, in step 1316, saving a payload corresponding to the at least one computer file to a distributed file system (DFS) and, in step 1316, receiving a payload content identifier (CID) from the DFS. The method 1300 may include, in step 1318, generating a payload database model and including the payload database model in a payload metadata file, the payload database model including at least a payload name, the payload CID, and a timestamp corresponding to payload creation.

The method 1300 may include encrypting the payload metadata file for recording. For ease of understanding, an encrypted payload metadata file may be referred to, interchangeably, as payload metadata file, unless context indicates to the contrary. Step 1320 includes saving data corresponding to the payload metadata file to the DFS and receiving a payload metadata CID. To register the payload immutably, the method 1300 may include step 1322, including broadcasting a (valid) blockchain transaction to or from an address generated by the electronic wallet, the blockchain transaction including carried data corresponding to the metadata CID. Step 1326 may include causing display, to the user in the GUI, a view 1500 including a payload control 1502 corresponding to the saved and recorded payload. In this way, the payload is registered to the blockchain via the carried data in the blockchain transaction. Since blockchain transactions cannot be changed after-the-fact, registering the payload to the blockchain creates an immutable record of the act of saving the payload.

In an embodiment, the method 1300 includes step 1312, which includes determining a hash of the at least one computer file 1410. The at least one computer file may also be referred to as the unencrypted payload elsewhere herein. Generating a payload database model and including the payload database model in a metadata file (in step 1818) may includes recording the hash of the at least one computer file (aka, the unencrypted payload) 1410 in the payload database model.

Determining the hash of the unencrypted payload may include calculating a SHA-2 hash, such as a SHA-256 hash. In another embodiment, determining the hash of the unencrypted payload includes calculating a SHA-3 hash.

Hashing of the unencrypted payload may be optional, such as in an extra-cost or upgrade option. In such case, the method 1300 may include receiving an indication, via a control in the GUI, that the payload is to be hashed (or fingerprinted).

In an embodiment, the method 1300 may include receiving an indication into the server computer, via a control in the GUI, that the payload is to be encrypted (or secret).

The method 1300 may further include establishing a payload password and encrypting the payload using symmetric encryption using the payload password. In another embodiment, the method 1300 may include encrypting the payload using an electronic wallet public key associated with the address generated from the electronic wallet representing the project. In an embodiment, and in some embodiments, according to a default behavior, the method 1300 may include step 1314, which includes encrypting the designated at least one computer file 1410. (The designated at least one computer file 1410 may also be referred to as the unencrypted payload and may be considered synonymous therewith.) Saving a payload corresponding to the at least one computer file to the DFS (in step 1316) may include saving the encrypted payload to the DFS and receiving the payload CID (in step 1316) may includes receiving the payload CID corresponding to the encrypted payload, such that the payload CID included in the generated payload database model is the payload CID corresponding to the encrypted payload.

Generating a payload database model and including the payload database model in a payload metadata file may includes creating the payload metadata file as a JavaScript Object Notation (JSON) file. Other formats are described elsewhere herein.

In an embodiment, the method 1300 may include encrypting the payload metadata file prior to saving the data corresponding to the payload metadata file to the DFS (in step 1320), such that the payload metadata file saved in the DFS is the encrypted payload metadata file. Correspondingly, receiving the payload metadata CID may include receiving a CID corresponding to the encrypted payload metadata file, and broadcasting the blockchain transaction to or from an address generated by the electronic wallet may include causing the blockchain transaction to include carried data corresponding to the payload metadata CID for the encrypted payload metadata file.

Broadcasting the blockchain transaction to or from the address generated by the electronic wallet (in step 1322) may include broadcasting the blockchain transaction with the payload metadata CID verbatim as carried data.

In an embodiment, the method 1300 may include encrypting the payload metadata CID, such that broadcasting the blockchain transaction to or from the address generated by the electronic wallet (in step 1322) includes broadcasting the blockchain transaction with the encrypted payload metadata CID as carried data.

Typically, broadcasting a blockchain transaction includes transmitting a small amount of cryptocurrency. For example, broadcasting the blockchain transaction referenced to the electronic wallet (in step 1322) may includes transmitting a small amount of cryptocurrency from a system-controlled electronic wallet to the referenced electronic wallet. Transmitting a small amount of cryptocurrency may include transferring dust sufficient to pay proof fees, with any remainder being received by the referenced electronic wallet. This is one aspect that makes the broadcast transaction valid. Currently (corresponding to dates shown in views of the GUI in the figures), the minimum amount of cryptocurrency in the transaction is 546 Satoshis.

Additionally or alternatively, broadcasting the blockchain transaction may be preceded by transferring a small amount of cryptocurrency into the referenced electronic wallet and broadcasting the blockchain transaction referenced to the electronic wallet (in step 1322) may include transmitting the small amount of cryptocurrency from the referenced electronic wallet to another electronic wallet, wherein transmitting the small amount of cryptocurrency includes transferring dust sufficient to pay proof fees, with any remainder being received by the other electronic wallet. In another embodiment, transmitting the small amount of cryptocurrency includes transferring dust sufficient to pay proof fees plus a hosting fee received by the other electronic wallet.

The method 1300 may include step 1312, including calculating a hash of the unencrypted payload corresponding to the designated at least one computer file. A payload database model generated in step 1318 for inclusion in the payload metadata may include generating the payload database model including the hash of the unencrypted payload.

In an embodiment, the method 1300 includes step 1314, which includes encrypting the designated at least one computer file 1410 such that saving a payload corresponding to the at least one computer file to the DFS (in step 1316) includes saving the encrypted payload to the DFS. Accordingly, receiving the payload CID (in step 1316) may include receiving the payload CID corresponding to the encrypted payload such that the payload CID included in the generated payload database model included in the payload metadata created in step 1318 is the payload CID corresponding to the encrypted payload. Thus, broadcasting a (valid) blockchain transaction to or from an address generated by the electronic wallet may include carried data corresponding to the payload CID (corresponding to a payload in encrypted form). Broadcasting the blockchain transaction to or from the address generated by the electronic wallet in step 1322 may include carried data corresponding to the payload CID verbatim.

Optionally, the method 1300 may include broadcasting a (valid) blockchain transaction to or from an address generated by the electronic wallet, wherein the blockchain transaction includes carried data corresponding to the payload CID. This may be done, for example, responsive to receiving, into the server computer from the user via the GUI, an indication that the designated at least one computer file should be referenced directly by a blockchain transaction.

In an embodiment, receiving, from the user via the GUI, input corresponding to designation of the electronic wallet to which the blockchain transaction is referenced in step 1302 may include receiving user input via the GUI to select an existing electronic wallet. For example, receiving user input via the GUI to select the existing electronic wallet includes receiving selection of an existing electronic wallet identifier (e.g., selection from a list or selection of a control (button) representing the existing electronic wallet. In another embodiment, the method 1300 may be combined with the method 900 (see FIG. 9) such that receiving input corresponding to designation of the electronic wallet includes receiving user input via the GUI to create a new electronic wallet.

In embodiments, the electronic wallet includes a (BIP44-type or BIP44-compliant) hierarchical deterministic (HD) wallet. In embodiments, the DFS includes IPFS. Additionally or alternatively, the DFS may include FileCoin. The blockchain described herein may include a public blockchain. According to embodiments, wherein the blockchain includes Bitcoin Cash (BCH).

According to an embodiment, a non-transitory computer readable medium carries instructions for causing a computer to execute a method including the steps of the method 1300, described above.

Payload Control

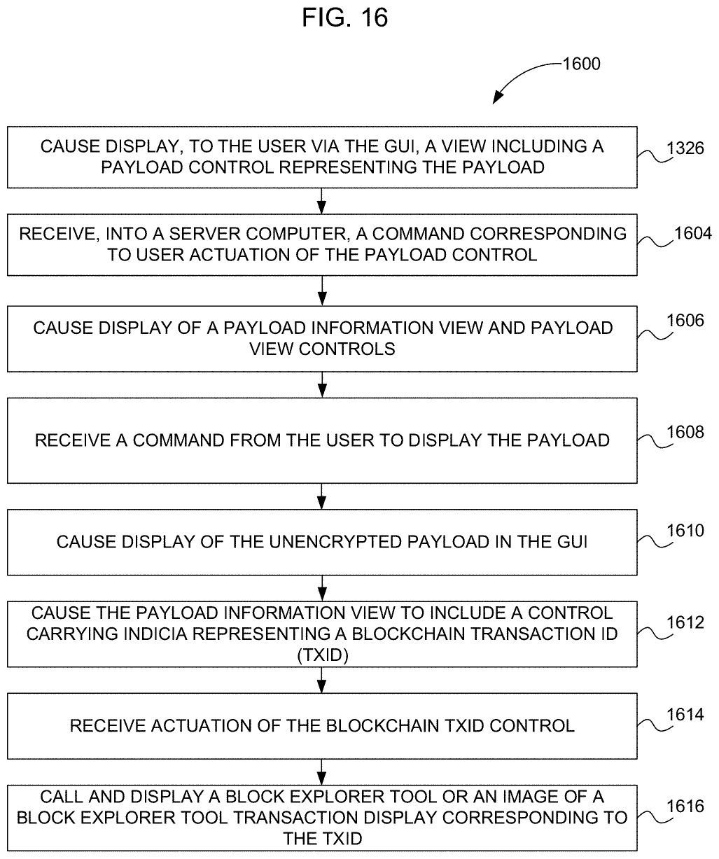

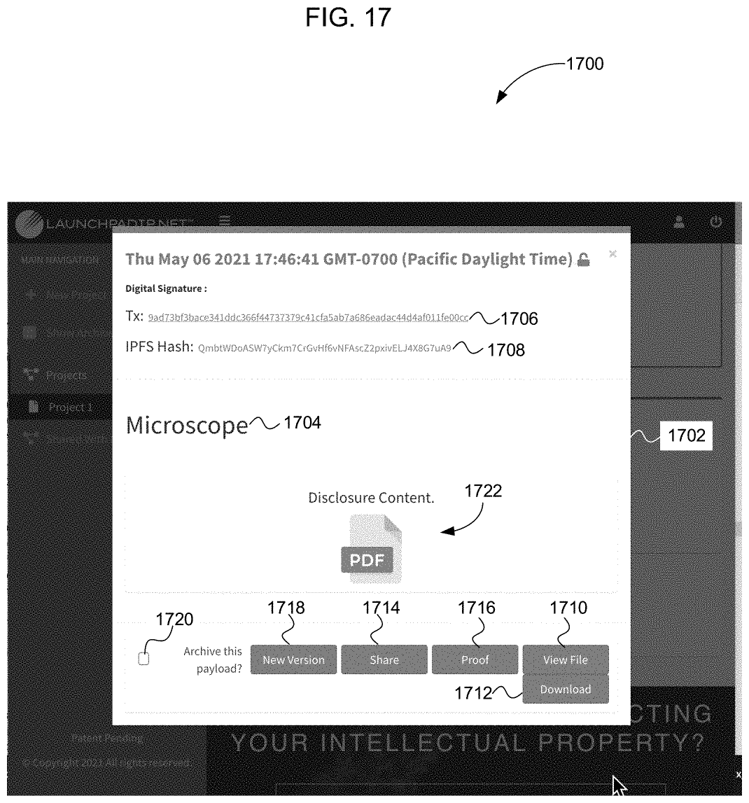

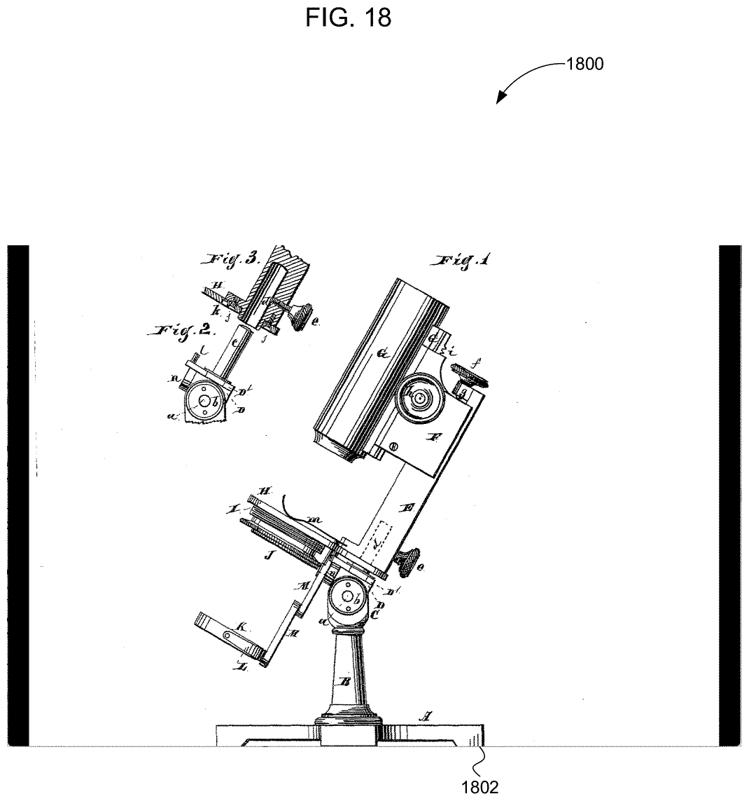

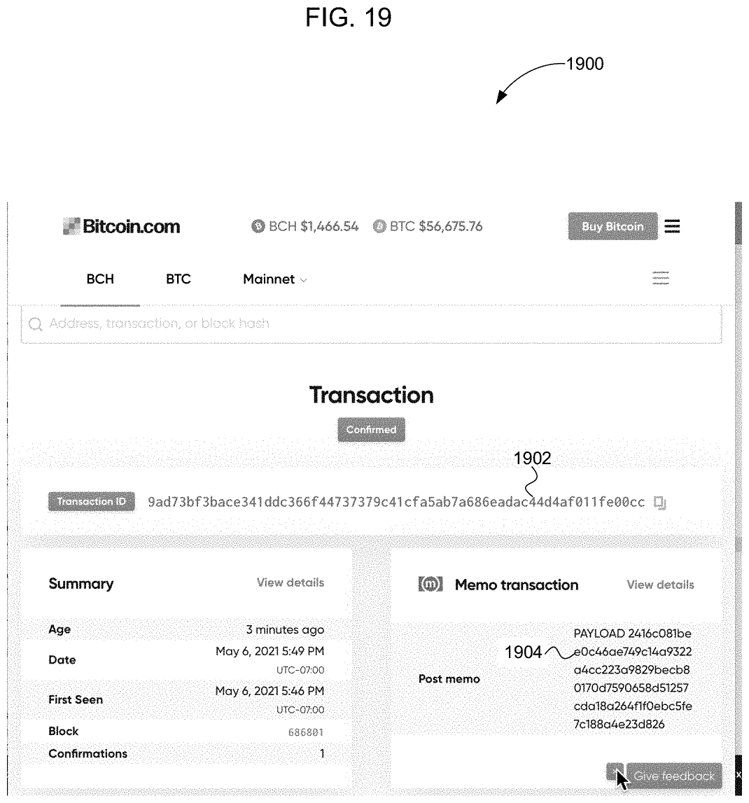

FIG. 16 is a flow chart showing a computer method 1600 for controlling aspects of the payload including payload viewing and blockchain transaction viewing, according to an embodiment. FIG. 17 is a view of a GUI 1700 including a payload control view 1702, according to an embodiment. FIG. 18 is a view of a GUI 1800 including a payload view 1802 displayed responsive to actuation of a view-file control 1704 in the payload control view 1702 of FIG. 17, according to an embodiment. FIG. 19 is a block explorer view 1099 corresponding to a transaction ID 1902 corresponding to broadcast of a blockchain transaction carrying data 1904 corresponding to a payload CID, made responsive to user actuation of a blockchain transaction ID (TX) 1706 displayed in they payload control view 1702 of FIG. 17, according to an embodiment.

According to embodiments, referring to FIG. 16 in view of FIGS. 15 and 17-19, computer methods 1600 for interacting with a payload include, in step 1602, causing display of a view including a payload control (see 1502, FIG. 15) representing the payload. The method may proceed to receiving a user command corresponding to user actuation of the payload control 1502. Referring to FIG. 17, the server computer may respond, in step 1606, by causing display of a payload information view 1702 including a payload name 1704 and payload view controls. The payload view controls may include a transaction ID (Tx) 1706 corresponding to a blockchain transaction carrying data corresponding to a payload metadata CID (or, optionally, a CID corresponding to the saved payload). Actuation of the Tx control may cause display of a block explorer view 1900 (FIG. 19) corresponding to the blockchain transaction. A DFS (IPFS) Hash 1708 corresponds to the CID corresponding to the stored payload metadata. A view file button 1710 causes the server computer to display the payload as shown, for example, as 1802 in FIG. 18. A download button 1712 may cause the payload to be downloaded in unencrypted, native format. (As described below, the download button 1712 may be omitted from a counterparty GUI.) A share button 1714, described below, starts computer method for sharing the payload with a counterparty. A proof button 1716, starts a computer proof method, described below. A new version button 1718 may cause archiving of the current payload, and launch a payload creation computer method (see FIGS. 7, 13A, and 13B) for receiving a new payload intended to replace the current payload.

Because blockchain transactions result in append-only data, the creation of the original payload cannot be deleted from the blockchain, but archiving the current payload may be followed by removing the original payload from the DFS. An archive control 1720 causes archiving of the current payload without replacing the current payload in the unarchived view. A disclosure content view 1722 may include a thumbnail of the unencrypted payload.

Payload Sharing

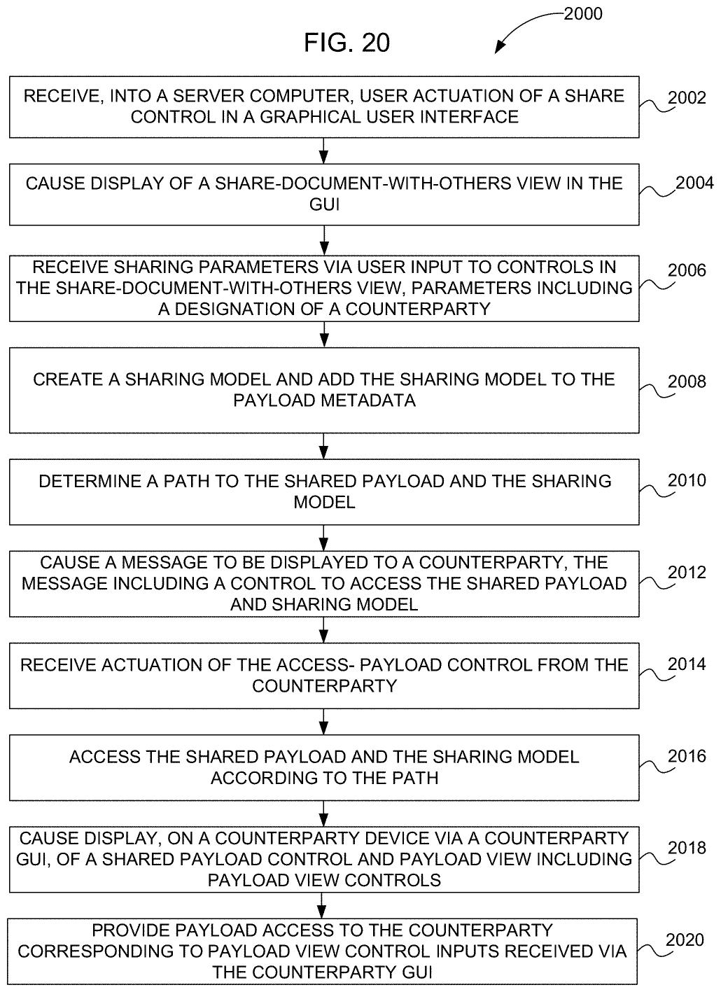

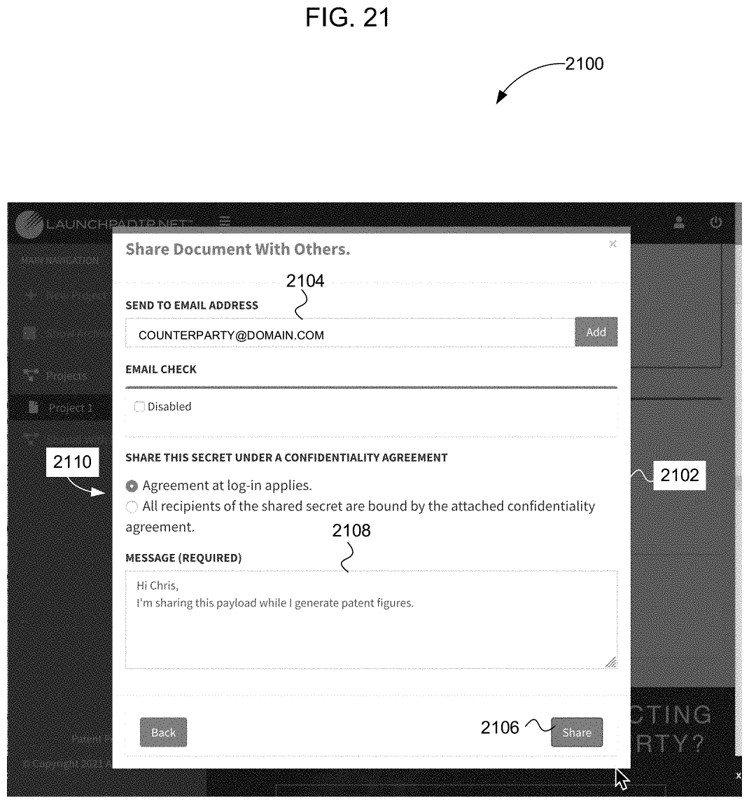

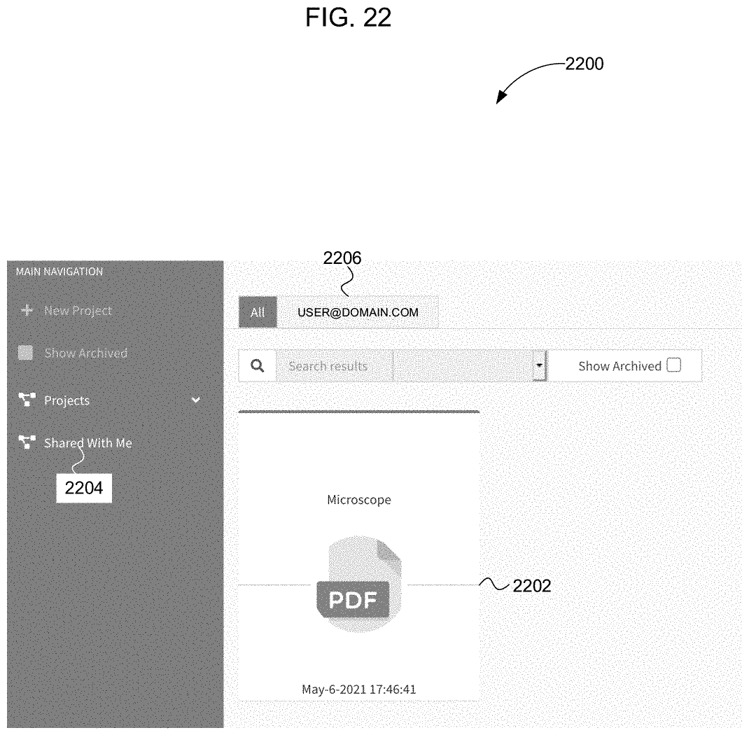

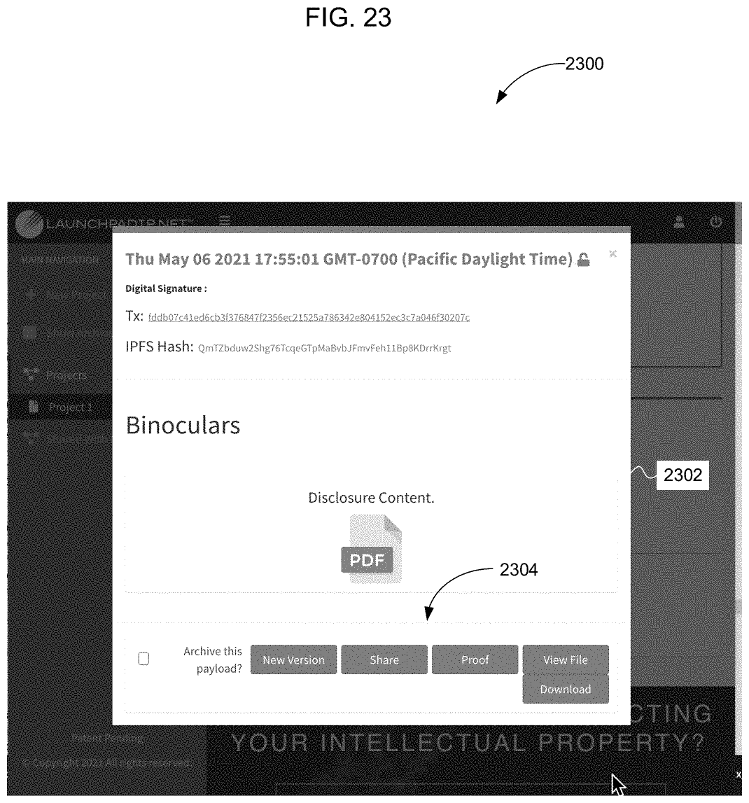

FIG. 20 is a flow chart showing a computer method 2000 for controlled sharing of a payload with a counterparty, according to an embodiment. FIG. 21 is a view of a GUI 2100 including a share-document-with-others control view 2102, according to an embodiment. FIG. 22 is a view of a counterparty GUI 2200 including a shared payload control 2202, according to an embodiment. FIG. 23 is a view of a payload control view 1702 displayed to the counterparty responsive to receiving the counterparty's actuation of the shared payload control 2202 of FIG. 22, according to an embodiment.

According to embodiments, referring to FIG. 20 in view of FIGS. 15 and 21-23, a computer method 2000 for controlled sharing of a payload with a counterparty may include, a step 1604 (See FIG. 16), including receiving, into the server computer from a user via a graphical user interface (GUI), selection of a payload control 1502 corresponding a payload data file in the context of an electronic wallet and, in step 2004, causing display of a share-document-with-others view 2102 in the GUI 2100, the share-document-with-others view 2102 including at least a counterparty designation control 2104 and a share actuation button 2106. Receiving the designation of the counterparty and the actuation to share the payload may includes receiving input in the counterparty designation control 2104 and receiving actuation of the share actuation button 2106.

Returning to FIG. 20, the method 2000 includes, in step 2002, receiving, into a server computer via a graphical user interface, an actuation of a share control 1714 in the context of a payload, in step 2006 receiving, from the user via a GUI into the server computer, a designation of a counterparty and an actuation to share the payload. The method 2000 may proceed to step 2008, including creating or updating shared permissions data to establish permissions for the counterparty, inserting shared permissions data into a payload metadata file, the shared permissions data including designation of the counterparty. An example of sharedPermissions data is shown below:

```
″sharedPermissions″: [
  {
    ″email″: ″user1@userland.com″,
    ″userid″: ″6058a50a6fb007487ce95fb6″,
    ″shareLevel″: 20,
    ″shareLevelText″: ″view-only-time-based″,
    ″shareEndDate″: 1619014652,
    “sharingPermission”: no
```

Proceeding to step 2010, an access path to a shared payload data file is determined. The method 2000 may include outputting the access path to the shared payload data file as at least an element of an invitation to the counterparty to access the shared payload data file.

Typically, at a later time, the method 2000 proceeds to step 2014, which includes receiving a log in to the server computer from the counterparty via a counterparty GUI. Responsively, in step 2020, the server computer may cause the payload to be displayed to the counterparty via a counterparty GUI.

Receiving, from the user via the GUI into the server computer, the designation of the counterparty may include receiving the designation of the counterparty into a counterparty designation control 2104, the counterparty being another party with whom a payload data file is to be shared.

The share-document-with-others view may include one or more controls 2108, 2110 for establishing sharing parameters. The method 2000 may include receiving, from the user via the GUI into the server computer, one or more sharing parameters.

In an embodiment, the method 2000 includes reading the payload metadata file to verify that the user has a privilege for sharing the payload data file.

Upon receiving the share commands from the user, the method may include determining that the counterparty is not a registered user. In such case, inserting shared permissions data into the payload metadata file includes creating a shadow user corresponding to the designated counterparty. Subsequently receiving the log in to the server computer from the counterparty via the counterparty GUI then includes updating the sharing permissions data to designate the counterparty user ID.

The method 2000 may include creating a shared payload data file. For example, creating the shared payload data file includes decrypting the payload data file with a first key or password and re-encrypting the unencrypted payload data file with a second key or password to create an encrypted shared payload data file different than the encrypted payload data file.

Creating the shared payload data file may include decrypting the payload data file, creating a watermarked version of the payload data file to create the shared payload data file different than the payload data file, encrypting the shared payload data file, saving the shared payload data file to the DFS; and updating the payload metadata to include information about the watermarked version of the payload data file. Creating a watermarked version of the payload data file may includes creating a version of the payload data file that is uniquely traceable to the counterparty. This approach may be useful for monitoring veracity of a counterparty confidentiality agreement.

The method 2000 may include step 2012, which includes causing a message to be displayed to the counterparty. The message may include a control to actuate the path to access the shared payload according to the sharing model. Causing a message to be displayed to the counterparty may include transmitting an invitation to the counterparty to access the shared payload data file.

In embodiments, the shared payload data file is the same file as the payload data file. Accordingly, the access path to the shared payload data file may be the same access path as the access path to the payload data file.

Receiving the log in from the counterparty to the server computer via the counterparty GUI may includes receiving actuation of an access payload control 2304 by the counterparty, as indicated in step 2014. The method 2000 may further include step 2016, including accessing the shared payload according to the permissions in the sharing model. The method 2000 may further include, after the counterparty accesses the shared payload data file (in step 2018 or 2020), recording access of the shared payload data file by the counterparty by creating a file access model recording the event, adding the file access model to the payload metadata to create updated payload metadata, encrypting the updated payload metadata, storing the encrypted updated payload metadata in the DFS, receiving an updated payload metadata CID corresponding to the encrypted updated payload metadata, and broadcasting a blockchain transaction, the blockchain transaction being referenced to the electronic wallet, the blockchain transaction including carried data corresponding to the updated payload metadata CID.

In an embodiment, after the counterparty accesses the shared payload data file (in step 2018 or 2020), the method 2000 may include notifying the user that the counterparty has accessed the shared payload data.

In an embodiment, after receiving the log in to the server computer from the counterparty (in step 2014), the method may include populating the counterparty GUI with a shared payload control, receiving a counterparty actuation of the shared payload control, determining sharing parameters established by the first user, and, in step 2018, displaying a counterparty payload control 2202 in the counterparty GUI. The method 2000 may include receiving actuation of the counterparty payload control 2202 and responsively displaying a counterparty payload view 2302 in the counterparty GUI 2300, the counterparty payload view 2302 including counterparty payload controls 2304. Displaying the payload view 2302 may include displaying counterparty payload controls consistent with the sharing permissions. For example, a counterparty granted view-only access would not have an active download control displayed on the counterparty payload view 2302.

According to embodiments, a non-transitory computer readable medium carries instructions for causing a computer to execute a method including the steps of the method 2000 described above.

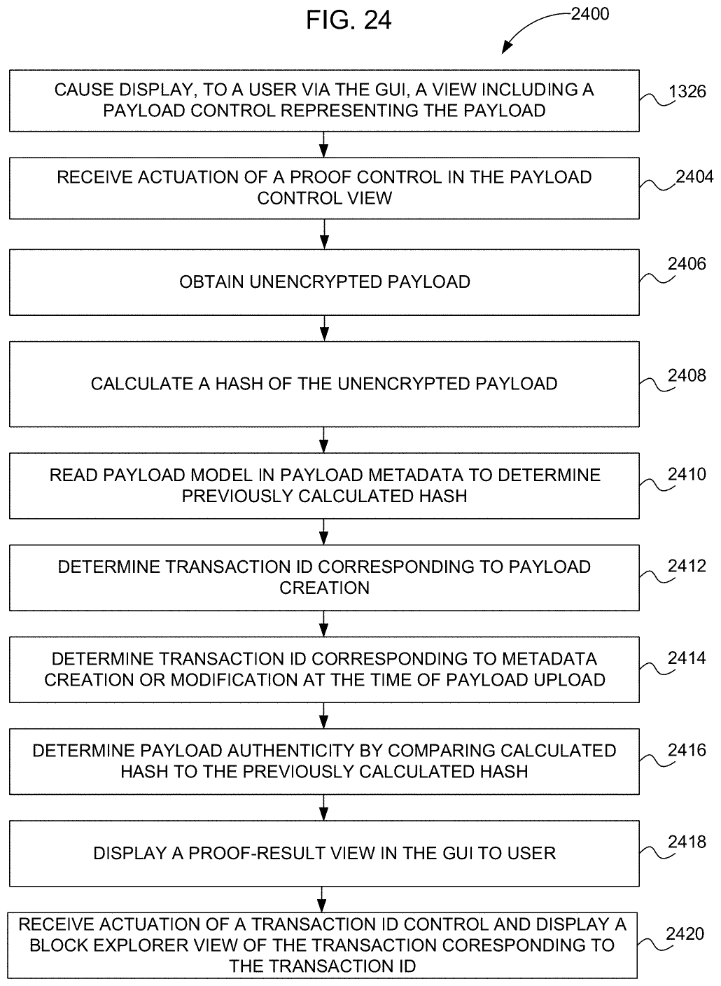

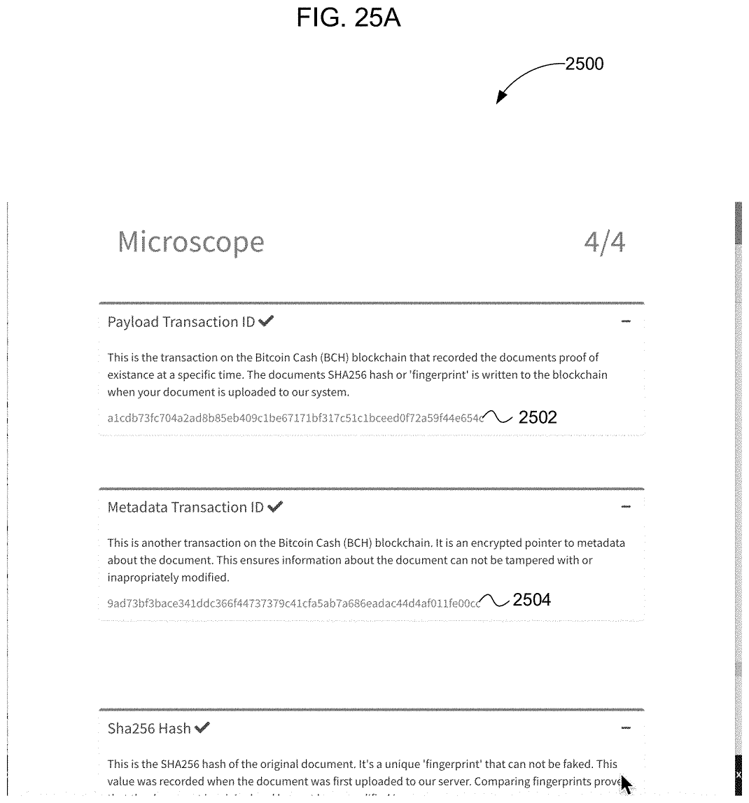

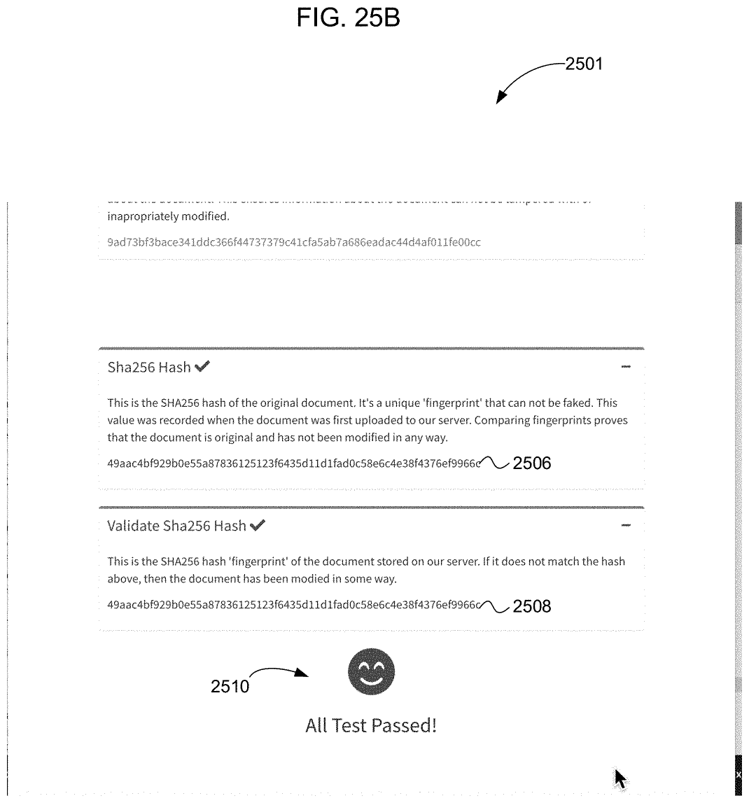

Proof or Certification of a Payload FIG. 24 is a flow chart showing a computer method 2400 for providing a proof or certification that a payload is genuine, according to an embodiment. FIG. 25A is a view 2500 of a GUI displayed to a user responsive to actuation of a proof control button 1716 in the payload control view 1702 of FIG. 17, according to an embodiment. FIG. 25B is another view 2501 of the GUI 2500 of FIG. 25A, according to an embodiment.

According to embodiments, referring to FIG. 24 in view of FIGS. 15, 17, and 21-23, a computer method 2400 for proving or certifying a payload includes a computer method for determining authenticity of a payload data file. The method 2400 may include causing display, to a user via a GUI displayed on an electronic display of a user electronic device, a view 1500 including a payload control 1502 (e.g., see FIGS. 13B and 15) and receiving actuation of the payload control 1502 by the user, which causes display, in step 1326 of a payload control view 1702 including a proof control 1716. Step 2404 includes receiving, into a server computer, actuation by the user of the proof control (button) 1716 in the context of the payload file, which causes the server computer to execute a proof method.

Executing a proof method may include, in step 2410, reading an old hash value from a pre-existing payload metadata file carrying metadata pertaining to the payload file, in step 2406, obtaining an unencrypted version of the payload file, in step 2408, calculating a new hash value for the unencrypted payload file; and, in step 2416, comparing the old hash value to the new hash value.

The hash values may include SHA-2 hash values. For example, the hash values include SHA-256 hash values. In another embodiment, the SHA-2 hash values include SHA-512 hash values. In another embodiment, the hash values include SHA-3 hash values.

The method may proceed to step 2418, which includes outputting, to the GUI, an indication 2500, 2501, 2510 of whether the pre-existing payload and the newly obtained payload are the same.

Outputting, in step 2418, an indication of whether the pre-existing payload and the newly obtained payload are the same may include outputting, to the GUI, a view 2500, 2501 including indication 2510 that the payload is genuine if the old hash value and the new hash value match. Alternatively, outputting, to the GUI, and indication of whether the pre-existing payload and the newly obtained payload are the same (in step 2418) includes may include outputting, to the GUI, an indication that the payload is not genuine if the old hash value and the new hash value do not match.

Outputting an indication of whether the pre-existing payload and the newly obtained payload are the same (in step 2418) may include outputting a view 2500, 2501, shown in FIGS. 25A and 25B, including the old hash value 2506 and the new hash value 2508.

Outputting an indication of whether the pre-existing payload and the newly obtained payload are the same (in step 2418) may include outputting a view 2500, 2501 including a payload metadata blockchain transaction ID 2502 corresponding to the payload metadata CID. In an embodiment, the payload metadata blockchain transaction ID 2502 may be formatted as a GUI control. The method 2400 may further include receiving user actuation of the payload metadata blockchain transaction ID 2502 control and displaying a view 1900 (See FIG. 19) of a block explorer including the blockchain transaction ID 1902.

Additionally or alternatively, outputting an indication of whether the pre-existing payload and the newly obtained payload are the same (in step 2418) may include outputting a view 2500, 2501 including a metadata blockchain transaction ID 2504 corresponding to a CID to a transaction history metadata file. The metadata blockchain transaction ID 2504 may also include a GUI control. Accordingly, the method 2400 may include receiving user actuation of the metadata blockchain transaction ID control 2504 and displaying a view 1900 of a block explorer including the metadata transaction ID 1902 and carried data 1904 including a CID corresponding to a transaction that recorded the transaction history metadata.

Obtaining an unencrypted version of the payload file in step 2406 may include reading a payload content identifier (CID) from the pre-existing metadata file reading a payload file associated with the CID from a distributed file system (DFS). The DFS may include InterPlanetary File System (IPFS) and/or FileCoin.

Obtaining an unencrypted version of the payload file (in step 2406) may thus include decrypting the payload file associated with the CID to produce the obtained unencrypted version of the payload file. In an embodiment, decrypting the payload file includes decrypting the payload file with a symmetric password. The payload file is associated with an electronic wallet, the electronic wallet being associated with a private key and a public key. Thus, decrypting the payload file may include decrypting the payload file with the private key.

In another embodiment, obtaining an unencrypted version of the payload file includes receiving a payload file from a location specified, via the GUI, by the user. Obtaining an unencrypted version of the payload file may optionally include, if the specified file is encrypted, decrypting the payload file received from the location specified by the user to produce the obtained unencrypted version of the payload file.

In an embodiment, executing the proof method includes reading an old payload CID from the pre-existing metadata file writing the obtained version of the payload file to the DFS receiving a new payload CID from the DFS, and comparing the old payload CID to the new payload CID. The method 2400 may include outputting, to the GUI, a view including an indication of whether the old payload CID and the new payload CID are the same.

Since a CID is a multihash of the saved file, comparing CIDs may provide another way of executing a proof. In an embodiment, executing the proof method includes reading an old payload CID from the pre-existing metadata file, encrypting the obtained unencrypted version of the payload file to produce an obtained encrypted version of the payload file, writing the obtained encrypted version of the payload file to the DFS, receiving a new obtained payload CID from the DFS, and comparing the old payload CID to the new obtained payload CID. The method 1400 may thus include outputting, to the GUI, an indication of whether the old payload CID and the new payload CID are the same based on the CID comparison.

The method 2400 may include, in step 2412, reading a blockchain transaction ID from a transaction log of an electronic wallet associated with the payload file, in step 2414, reading carried data from the blockchain transaction ID, and using the carried data from the blockchain transaction ID to obtain the pre-existing metadata file. Reading carried data from the blockchain transaction ID may includes reading data carried in a memo field of the blockchain transaction. For example, reading carried data from the blockchain transaction ID includes reading data carried in an OP_RETURN field of the blockchain transaction.

In an embodiment, wherein using the carried data from the blockchain transaction ID to obtain the pre-existing metadata file may include generating a metadata CID from the carried data and reading the pre-existing metadata file from a DFS using the CID. Generating the metadata CID from the carried data may include decrypting the carried data to obtain the metadata CID. In one embodiment, decrypting the carried data to obtain the metadata CID includes performing symmetric decryption of the carried data using a symmetric password. In another embodiment, decrypting the carried data to obtain the metadata CID includes performing asymmetric decryption using a private key associated with the electronic wallet.

In an embodiment, the method 2400 includes reading a blockchain transaction ID from a transaction log of an electronic wallet associated with the payload file and reading carried data from the blockchain transaction ID. Obtaining the unencrypted version of the payload file may include using the carried data from the blockchain transaction ID to obtain the unencrypted version of the payload file. Using the carried data from the blockchain transaction ID to obtain the unencrypted version of the payload file may include extracting a payload CID from the carried data reading the payload file from a DFS using the CID. Extracting a payload CID from the carried data may include decrypting the carried data to produce the payload CID or may include parsing an unencrypted payload CID from the carried data.

In an embodiment, the payload file from the DFS is encrypted. Obtaining the unencrypted payload, in step 2406 may include decrypting the payload file from the DFS to produce the unencrypted payload file.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1.-119. (canceled)

120. A computer method for determining authenticity of a payload data file, comprising the steps of:
receiving, into a server computer via a graphical user interface GUI displayed on an electronic display of a user device, actuation by a user of a proof control in the context of a payload file;
executing a proof method including:
reading an old hash value from a pre-existing payload metadata file carrying metadata pertaining to the payload file;
obtaining an unencrypted version of the payload file;
calculating a new hash value for the unencrypted payload file;
comparing the old hash value to the new hash value; and
outputting, to the GUI, an indication of whether the pre-existing payload and the newly obtained payload are the same if and only if the old hash value and the new hash value match.

121. The computer method for determining authenticity of a payload data file of claim 120, further comprising:
causing display, to the user via the GUI, of a view including a payload control;
receiving actuation of the payload control by the user;
causing display, in the GUI, of a payload control view including the proof control.

122. (canceled)

123. The computer method for determining authenticity of a payload data file of claim 120, wherein outputting, to the GUI, and indication of whether the pre-existing payload and the newly obtained payload are the same includes outputting, to the GUI, an indication that the payload is not genuine if the old hash value and the new hash value do not match.

124. The computer method for determining authenticity of a payload data file of claim 120, wherein outputting an indication of whether the pre-existing payload and the newly obtained payload are the same includes outputting a view including the old hash value and the new hash value.

125. The computer method for determining authenticity of a payload data file of claim 120, wherein outputting an indication of whether the pre-existing payload and the newly obtained payload are the same includes outputting a view including a payload metadata blockchain transaction ID corresponding to a CID corresponding to the saved payload metadata.

126. The computer method for determining authenticity of a payload data file of claim 125, wherein the displayed payload metadata blockchain transaction ID is a GUI control;
further comprising:
receiving user actuation of the payload metadata blockchain transaction ID control; and
displaying a view of a block explorer including the blockchain transaction ID.

127. The computer method for determining authenticity of a payload data file of claim 120, wherein outputting an indication of whether the pre-existing payload and the newly obtained payload are the same includes outputting a view including a metadata blockchain transaction ID corresponding to a CID to a transaction history metadata file.

128. The computer method for determining authenticity of a payload data file of claim 127, wherein the metadata blockchain transaction ID is a GUI control;
further comprising:
receiving user actuation of the metadata blockchain transaction ID control; and
displaying a view of a block explorer including the metadata transaction ID and carried data including a CID corresponding to a transaction that recorded the transaction history metadata.

129. The computer method for determining authenticity of a payload data file of claim 120, wherein the hash values include SHA-256 hash values.

130. The computer method for determining authenticity of a payload data file of claim 120, wherein obtaining an unencrypted version of the payload file includes:
reading a payload CID from the pre-existing metadata file; and
reading the payload file associated with the CID from a distributed file system (DFS).

131. The computer method for determining authenticity of a payload data file of claim 120, wherein obtaining an unencrypted version of the payload file includes:
receiving a payload file from a location specified, via the GUI, by the user.

132. The computer method for determining authenticity of a payload data file of claim 131, wherein obtaining an unencrypted version of the payload file includes:
decrypting the payload file received from the location specified by the user to produce the obtained unencrypted version of the payload file.

133. The computer method for determining authenticity of a payload data file of claim 120, wherein executing the proof method further comprises:
reading an old payload CID from the pre-existing metadata file;
writing the obtained version of the payload file to the DFS;
receiving a new payload CID from the DFS; and
comparing the old payload CID to the new payload CID; and
outputting, to the GUI, a view including an indication of whether the old payload CID and the new payload CID are the same.

134. The computer method for determining authenticity of a payload data file of claim 120, wherein executing the proof method further comprises:
reading an old payload CID from the pre-existing metadata file;
encrypting the obtained unencrypted version of the payload file to produce an obtained encrypted version of the payload file;
writing the obtained encrypted version of the payload file to the DFS;
receiving a new obtained payload CID from the DFS; and
comparing the old payload CID to the new obtained payload CID; and
further comprising:
outputting, to the GUI, an indication of whether the old payload CID and the new payload CID are the same.

135. The computer method for determining authenticity of a payload data file of claim 120, further comprising:
reading a blockchain transaction ID from a transaction log of an electronic wallet associated with the payload file;
reading carried data from the blockchain transaction ID; and
using the carried data from the blockchain transaction ID to obtain the pre-existing metadata file.

136. The computer method for determining authenticity of a payload data file of claim 135, wherein reading carried data from the blockchain transaction ID includes reading data carried in a memo field of the blockchain transaction.

137. The computer method for determining authenticity of a payload data file of claim 136, wherein reading carried data from the blockchain transaction ID includes reading data carried in an OP_RETURN field of the blockchain transaction.

138. The computer method for determining authenticity of a payload data file of claim 135, wherein using the carried data from the blockchain transaction ID to obtain the pre-existing metadata file includes:
extracting a metadata CID from the carried data; and
reading the pre-existing metadata file from a DFS using the extracted CID.

139. The computer method for determining authenticity of a payload data file of claim 138, wherein extracting a metadata CID from the carried data includes:
decrypting the carried data to obtain the metadata CID.

140. The computer method for determining authenticity of a payload data file of claim 120, further comprising:
reading a blockchain transaction ID from a transaction log of an electronic wallet associated with the payload file; and
reading carried data from the blockchain transaction ID;
wherein obtaining the unencrypted version of the payload file includes using the carried data from the blockchain transaction ID to obtain the unencrypted version of the payload file.

141. The computer method for determining authenticity of a payload data file of claim 140, wherein using the carried data from the blockchain transaction ID to obtain the unencrypted version of the payload file includes:
generating a payload CID from the carried data; and
reading the payload file from a DFS using the CID.

142. A non-transitory computer readable medium carrying instructions for causing a computer to execute a method including the steps of claim 120.
